(19) United States
(12) Patent Application Publication
(10) Pub. No.: US 2018/0176931 A1
(43) Pub. Date: Jun. 21, 2018

(54) TRANSMISSION SCHEDULE NEGOTIATION

(71) Applicant: QUALCOMM Incorporated, San Diego, CA (US)

(72) Inventors: Abhishek Pramod PATIL, San Diego, CA (US); Santosh Paul ABRAHAM, San Diego, CA (US); George CHERIAN, San Diego, CA (US); Alireza RAISSINIA, Monte Sereno, CA (US); Shivraj Singh SANDHU, Milpitas, CA (US)

(21) Appl. No.: 15/886,580

(22) Filed: Feb. 1, 2018

Related U.S. Application Data
(63) Continuation of application No. 15/495,556, filed on Apr. 24, 2017.
(60) Provisional application No. 62/327,077, filed on Apr. 25, 2016.
(60) Provisional application No. 62/327,975, filed on Apr. 26, 2016.
(60) Provisional application No. 62/343,580, filed on May 31, 2016.
(60) Provisional application No. 62/355,288, filed on Jun. 27, 2016.
(60) Provisional application No. 62/374,644, filed on Aug. 12, 2016.
(60) Provisional application No. 62/380,949, filed on Aug. 29, 2016.

(51) Int. Cl. H04W 72/12; H04W 52/02; H04W 68/02; H04L 29/08; H04W 8/00; H04W 4/06

(52) U.S. Cl. CPC H04W 72/121; H04W 52/0216; H04W 68/02; H04W 72/1226; H04W 8/005; H04W 4/06; H04L 67/16

(57) ABSTRACT

A method, an apparatus, and a computer-readable medium for wireless communication are provided. In one aspect, the apparatus may be configured to determine a many-to-many multicast schedule for an NDL of a service associated with a NAN network and to communicate with a plurality of wireless devices subscribed to the service based on the determined many-to-many multicast schedule. The apparatus may be a schedule owner of the many-to-many multicast schedule.

### CROSS-REFERENCE TO RELATED APPLICATION(S)

This application is a continuation of U.S. Non-Provisional application Ser. No. 15/495,556, entitled “NEIGHBOR AWARENESS NETWORKING SCHEDULE NEGOTIATION” and filed on Apr. 24, 2017, which claims the benefit of U.S. Provisional Application Ser. No. 62/327,077, entitled “MANY-TO-MANY MULTICAST SCHEDULE NEGOTIATION” and filed on Apr. 25, 2016, U.S. Provisional Application Ser. No. 62/327,975, entitled “NEIGHBOR AWARENESS NETWORKING SCHEDULE NEGOTIATION” and filed on Apr. 26, 2016, U.S. Provisional Application Ser. No. 62/343,580, entitled “NEIGHBOR AWARENESS NETWORKING SCHEDULE NEGOTIATION” and filed on May 31, 2016, U.S. Provisional Application Ser. No. 62/355,288, entitled “NEIGHBOR AWARENESS NETWORKING SCHEDULE NEGOTIATION” and filed on Jun. 27, 2016, U.S. Provisional Application Ser. No. 62/374,644, entitled “NEIGHBOR AWARENESS NETWORKING SCHEDULE NEGOTIATION” and filed on Aug. 12, 2016, U.S. Provisional Application Ser. No. 62/380,949, entitled “NEIGHBOR AWARENESS NETWORKING SCHEDULE NEGOTIATION” and filed on Aug. 29, 2016, which are incorporated by reference in their entirety.

### BACKGROUND

### Field

The present disclosure relates generally to communication systems, and more particularly, to many-to-many multicast schedule negotiation and control channel schedule negotiation.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims, which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., a station) for wireless communication. The apparatus may be configured to determine a many-to-many multicast schedule for a neighbor awareness networking (NAN) data link (NDL) of a service associated with a NAN network and to communicate with a plurality of wireless devices subscribed to the service based on the determined many-to-many multicast schedule. The apparatus may be a schedule owner of the many-to-many multicast schedule.

Another aspect of this disclosure provides an apparatus (e.g., a station) for wireless communication. The apparatus may be configured to receive a many-to-many multicast schedule for a NDL of a service associated with a NAN network and to communicate over the NDL based on the received many-to-many multicast schedule.

Another aspect of this disclosure provides an apparatus (e.g., a station) for wireless communication. The apparatus may include means for determining a many-to-many multicast schedule for a neighbor awareness networking (NAN) data link (NDL) of a service associated with a NAN network and means for communicating with a plurality of wireless devices subscribed to the service based on the determined many-to-many multicast schedule. The apparatus may be a schedule owner of the many-to-many multicast schedule.

Another aspect of this disclosure provides an apparatus (e.g., a station) for wireless communication. The apparatus may include means for receiving a many-to-many multicast schedule for a NDL of a service associated with a NAN network and means for communicating over the NDL based on the received many-to-many multicast schedule.

Another aspect of this disclosure provides a computer-readable medium of an apparatus storing computer executable code. The computer-readable medium may include code to determine a many-to-many multicast schedule for a neighbor awareness networking (NAN) data link (NDL) of a service associated with a NAN network and to communicate with a plurality of wireless devices subscribed to the service based on the determined many-to-many multicast schedule. The apparatus may be a schedule owner of the many-to-many multicast schedule.

Another aspect of this disclosure provides a computer-readable medium of an apparatus storing computer executable code. The computer-readable medium may include code to receive a many-to-many multicast schedule for a NDL of a service associated with a NAN network and to communicate over the NDL based on the received many-to-many multicast schedule.

Another aspect of this disclosure provides a wireless device (e.g., a station) for wireless communication. The wireless device may be configured to determine a many-to-many multicast schedule for an NDL of a service associated with a NAN network and to communicate with a plurality of wireless devices subscribed to the service based on the determined many-to-many multicast schedule. In an aspect, the many-to-many multicast schedule for the NDL may include repeating time-frequency blocks (TBs) between discovery windows (DWs), and a first subset of the repeating TBs is on a same channel or a different channel than a second subset of the repeating TBs. In another aspect, the wireless device may be configured to transmit the determined many-to-many multicast schedule. In another aspect, the wireless device initiated the many-to-many multicast schedule for the NDL of the service, and the many-to-many multicast schedule is immutable. In another aspect, the wireless device initiated the many-to-many multicast schedule for the NDL of the service, and only the wireless device is allowed to modify the many-to-many multicast schedule. In another aspect, the transmitted many-to-many multicast schedule includes a first timestamp based on a NAN clock associated with the NAN. In this aspect, the wireless device may be further configured to adjust the many-to-many multicast schedule and to transmit the adjusted many-to-many multicast schedule with a second timestamp based on the NAN clock. In an aspect, the wireless device may be further configured to receive a request to modify the determined many-to-many multicast schedule from a second wireless device associated with the service. In another aspect, the wireless device may be further configured to adjust the many-to-many multicast schedule based on the received request if the received request includes a schedule modification compatible with the NDL of the service. In an aspect, the wireless device that initiated the service is the only wireless device allowed to modify the determined many-to-many multicast schedule. In another aspect, the wireless device may be further configured to rebroadcast the received request to modify the determined many-to-many multicast schedule for the NDL of the service associated with the NAN network. In another aspect, the wireless device may be further configured to adjust the many-to-many multicast schedule and to transmit the adjusted many-to-many multicast schedule. In another aspect, the wireless device may be configured to determine the many-to-many multicast schedule by receiving the many-to-many multicast schedule in a schedule announcement, by determining autonomously to utilize the received many-to-many multicast schedule based on an availability of the wireless device, and by rebroadcasting the many-to-many multicast schedule based on the determination to utilize the received many-to-many schedule. In another aspect, the wireless communication device may be further configured to determine the many-to-many multicast schedule further by receiving the many-to-many multicast schedule in a schedule announcement and by rebroadcasting the many-to-many multicast schedule. In another aspect, the wireless device may be further configured to receive a plurality of messages from a plurality of wireless devices. Each message may include a many-to-many multicast schedule and a status indicator associated with each wireless device of the plurality of wireless devices, and the determined many-to-many multicast schedule may be based on at least one of the received many-to-many multicast schedules or the status indicator. In another aspect, the determination is further based on an availability of the wireless device. In another aspect, the status indicator is a function of a status of each wireless device. In another aspect, the status indicator is based on at least one of a timing synchronization function, a medium access control (MAC) address, a schedule quality indicator, a NAN master rank, or a service assigned value. In another aspect, the wireless device may be further configured to rebroadcast the determined many-to-many multicast schedule based on an autonomous decision to utilize the many-to-many multicast schedule. In another aspect, the wireless device may be further configured to periodically transmit a message associated with the service. The message may be transmitted within a lifetime associated with the determined many-to-many multicast schedule. In another aspect, the lifetime may be indicated during an NDL setup, is a property of the service, is a property of the NAN, or is defined in a NAN standard. In another aspect, the periodically transmitted message enables a determination of a presence of the wireless device. In another aspect, the message is a schedule announcement or a data frame. In another aspect, the wireless device may be further configured to determine that an originator of the service is inactive on the service and to determine to transmit an updated many-to-many multicast schedule based on the determination that the originator of the service is inactive. In another aspect, the wireless device may be configured to determine that the originator of the service is inactive by receiving a message from a second wireless device and by determining if the message is received from the originator by comparing a medium access control (MAC) address for a transmitter of the received message with a NAN multicast service group (NMSG) identifier (NMSG-ID). In another aspect, the NMSG-ID is based on an originator MAC address and a session ID. In another aspect, the wireless device is configured to determine the many-to-many multicast schedule by receiving the many-to-many multicast schedule in a schedule announcement and by determining autonomously to utilize the received many-to-many multicast schedule based on an availability of the wireless device. In an aspect, the wireless device may determining the many-to-many multicast schedule by rebroadcasting the many-to-many multicast schedule based upon the determination to utilize the received many-to-many multicast schedule. In another aspect, the wireless device may determine that an originator of the service is inactive on the service, receive at least one many-to-many multicast schedules, and select one of the at least one many-to-many multicast schedules. In another aspect, the selection is based on timing information, a medium access control (MAC) address, or a status value. In another aspect, the wireless device may be further configured to receive at least one schedule announcement for the NDL of the service from a plurality of wireless devices during a schedule time period. Each schedule announcement may include a corresponding many-to-many schedule and an indicator. In another aspect, the schedule time period may include one or more multiples of a lifetime value associated with the many-to-many multicast schedule. In another aspect, the schedule time period is indicated during an NDL setup, is a property of the service, is a property of the NAN, or is defined in a NAN standard. In another aspect, the schedule time period is indicated in a schedule update message. In another aspect, the at least one schedule announcement is received one or more discovery windows before the end of the schedule time period. In another aspect, the wireless device may be further configured to transmit a second schedule announcement based on the received at least one schedule announcement. The second schedule announcement may include a second many-to-many multicast schedule and a second indicator, and the second many-to-many multicast schedule may be based on a link quality of the determined many-to-many multicast schedule. In another aspect, the second indicator indicates a higher schedule quality than indicators in the received at least one schedule announcement. In another aspect, the second indicator is based on at least one of a timing synchronization function, a medium access control (MAC) address, a schedule quality indicator, a NAN master rank, or a service assigned value. In another aspect, the wireless device may be further configured to select, during the schedule time period, a second many-to-many multicast schedule, based on the received at least one schedule announcement, for communicating with the service at a beginning of a next schedule time period. In another aspect, the selection is based on the indicator included in each schedule announcement, and the wireless device may be further configured to rebroadcast the second many-to-many multicast schedule. In an aspect, the wireless device may be configured to determine the many-to-many multicast schedule by receiving a plurality schedule announcements from a plurality of wireless devices and by identifying a subset of the plurality of schedule announcements that are compatible with an availability of the wireless device. The many-to-many multicast schedule may be based on the identified subset. In another aspect, the wireless device may be further configured to transmit a schedule announcement indicating the availability of the wireless device. In another aspect, the wireless device may be configured to determine the many-to-many multicast schedule by identifying one or more inactive periods within the many-to-many multicast schedule and by updating the many-to-many multicast schedule based on the identified one or more inactive periods. In another aspect, the wireless device may be configured to determine the many-to-many multicast schedule by determining a countdown value associated with a schedule request, by repeatedly transmitting the schedule request when the countdown value is greater than zero, in which the schedule request includes the many-to-many multicast schedule and an indicator, by decrementing the countdown value after each transmission of the schedule request, and by determining if a schedule rejection message is received from another wireless device with a higher priority indicator based on the transmitted schedule request. In another aspect, the schedule request is transmitted within a beacon via a NAN data cluster (NDC) scheduled time blocks. In another aspect, the indicator is based on at least one of a timing synchronization function, a medium access control (MAC) address, a schedule quality indicator, a NAN master rank, or a service assigned value. In another aspect, the indicator is a lexicographical priority value assigned in a lexicographical order. In another aspect, the indicator has a higher priority than a second indicator with a longer lexicographical priority value, and the indicator has a lower priority than a third indicator with a same lexicographical priority value length but a lesser lexicographical priority value. In another aspect, the indicator is based on a number of enrollees in the service, a length of time that the wireless device joined the NAN network, a preference parameter associated with the service, and a random number. In another aspect, the wireless device may be configured to determine the many-to-many multicast schedule by refraining from transmitting the schedule request if the schedule rejection message is received or by transmitting a change schedule message if no schedule rejection message is received and the countdown value is zero. In another aspect, at least one of the schedule request, the change schedule message, or the schedule rejection message is encrypted with a common group key (CGK) associated with the NDL. In another aspect, the wireless device may be configured to determine the many-to-many multicast schedule by receiving a schedule request that includes a requested many-to-many multicast schedule and an indicator value, by rebroadcasting the requested many-to-many multicast schedule if the requested many-to-many multicast schedule is compatible with the wireless device, and by transmitting a schedule rejection message if the requested many-to-many multicast schedule is unsuitable for the wireless device and the wireless device is associated with a second indicator value that is of equal or greater priority than the indicator value in the schedule request. In another aspect, the wireless device rebroadcasts the requested many-to-many multicast schedule if the wireless device is an enroller of the service. In another aspect, the schedule request is received from a second wireless device via a third wireless device, the schedule rejection message is transmitted to the third wireless device for relaying to the second wireless device, and the schedule rejection message includes the second indicator value. In another aspect, the wireless device may be further configured to receive a second schedule request from a third wireless device. The schedule request may be received from a second wireless device, and the schedule rejection message is transmitted only to the second wireless device. In another aspect, the schedule rejection message is transmitted via unicast or multicast. In another aspect, the schedule rejection message is transmitted via unicast to an enroller device of the wireless device or to a neighboring enroller device if the enroller device is unavailable. In another aspect, the schedule rejection message is encrypted for transmission by a pairwise unicast key established between the wireless device and the enroller device or between the wireless device and the neighboring enroller device. In another aspect, the wireless device may be further configured to receive a second schedule rejection message from another wireless device and to transmit the second schedule rejection message. In another aspect, the wireless device transmits the second schedule rejection message if the wireless device is an enroller associated with the service. In another aspect, the second schedule rejection message is transmitted via unicast to an enroller device of the wireless device or to a neighboring enroller device if the enroller device is unavailable. In another aspect, the second schedule rejection message is encrypted for transmission by a pairwise unicast key established between the wireless device and the enroller device or between the wireless device and the neighboring enroller device. In another aspect, the wireless device may be configured to determine the many-to-many multicast schedule by receiving a change schedule message that includes the many-to-many multicast schedule and by rebroadcasting the many-to-many multicast schedule. In another aspect, the change schedule message includes a time indication indicating when the many-to-many multicast schedule will become effective. In another aspect, the wireless device may be configured to determine the many-to-many multicast schedule further by adopting the many-to-many multicast schedule based on the time indication indicated in the change schedule message. In another aspect, the wireless device is a schedule owner device, and the wireless device may be further configured to determine to change the many-to-many multicast schedule to a new many-to-many multicast schedule and to transmit the new many-to-many multicast schedule. In another aspect, the wireless device may be further configured to receive, from a second device, a change schedule request to change the many-to-many multicast schedule. In this aspect, the determination to change the many-to-many multicast schedule is based on the change schedule request. In another aspect, the wireless device may be further configured to transmit, to the second device, an acceptance message in response to the change schedule request if the wireless device determines to change the many-to-many multicast schedule and to transmit, to the second device, a rejection message in response to the change schedule request if the wireless device determines not to change the many-to-many multicast schedule. In an aspect, the determination to change the many-to-many multicast schedule is based on at least one of a quality of service (QoS) condition, a latency condition, or suitability of the new many-to-many multicast schedule. In another aspect, the wireless device is a schedule owner device, and the wireless device may be further configured to periodically transmit a periodic message, and the periodic message enables a determination of a presence of the schedule owner device. In another aspect, the periodic message includes at least one of the many-to-many multicast schedule or a new many-to-many multicast schedule. In another aspect, the wireless device may be further configured to receive one or more change schedule requests from one or more devices to change the many-to-many multicast schedule, to buffer the one or more change schedule requests until a next transmission of the periodic message, to determine to change the many-to-many multicast schedule to a new many-to-many multicast schedule based on the one or more change schedule requests, and to transmit, during the next transmission, the periodic message including the new many-to-many multicast schedule. In another aspect, the wireless device may be further configured to transmit a receipt acknowledgment to the one or more devices upon receiving the one or more change schedule requests. In another aspect, the receipt acknowledgment indicates presence of the schedule owner device. In another aspect, the wireless device may be further configured to transmit a change schedule request to a schedule owner device.

Another aspect of this disclosure provides a wireless device (e.g., a station) for wireless communication. The wireless device may be configured to determining a control channel schedule for a neighbor awareness networking (NAN) data cluster (NDC) associated with a NAN network and to communicate control information with a plurality of wireless devices based on the determined control channel schedule. In an aspect, the control channel schedule for the NDC may include repeating time-frequency blocks (TBs) between discovery windows (DWs), and a first subset of the repeating TBs is on a same channel or a different channel than a second subset of the repeating TBs. In another aspect, the wireless device may be further configured to transmit the determined control channel schedule. In another aspect, the wireless device initiated the NDC, and the control channel schedule is immutable. In another aspect, the wireless device initiated the control channel schedule, and only the wireless device is allowed to modify the control channel schedule. In another aspect, the transmitted control channel schedule includes a first timestamp based on a NAN clock associated with the NAN, the wireless device may be further configured to adjust the control channel schedule and to transmit the adjusted control channel schedule with a second timestamp based on the NAN clock. In another aspect, the wireless device may be further configured to receive a request to modify the determined control channel schedule from a second wireless device associated with the NDC. In another aspect, the wireless device may be further configured to adjust the control channel schedule based on the received request if the received request includes a schedule modification compatible with the NDC, and the wireless device that initiated the NDC is the only wireless device allowed to modify the determined control channel schedule. In another aspect, the wireless device may be further configured to rebroadcast the received request to modify the determined control channel schedule for the NDC associated with the NAN network. In another aspect, the wireless device may be further configured to adjust the control channel schedule and to transmit the control channel schedule. In another aspect, the wireless device may be configured to determine the control channel schedule by receiving the control channel schedule in a schedule announcement, by determining autonomously to utilize the received control channel schedule based on an availability of the wireless device, and by rebroadcasting the control channel schedule based on the determination to utilize the received control channel schedule. In another aspect, the wireless device may be configured to determine the control channel schedule by receiving the control channel schedule in a schedule announcement and by rebroadcasting the control channel schedule. In another aspect, the wireless device may be further configured to receive a plurality of messages from a plurality of wireless devices. Each message may include a control channel schedule and a status indicator associated with each wireless device of the plurality of wireless devices, and the determined control channel schedule is based on at least one of the received control channel schedules or the status indicator. In another aspect, the determination is further based on an availability of the wireless device. In another aspect, the status indicator is a function of a status of each wireless device. In another aspect, the status indicator is based on at least one of a timing synchronization function, a medium access control (MAC) address, a schedule quality indicator, a NAN master rank, or a service assigned value. In another aspect, the wireless device may be further configured to rebroadcast the determined control channel schedule based on an autonomous decision to utilize the control channel schedule. In another aspect, the wireless device may be further configured to periodically transmit a message associated with the NDC, and the message is transmitted within a lifetime associated with the determined control channel schedule. In another aspect, the lifetime is indicated during an NDC setup, is a property of the NAN, or is defined in a NAN standard. In another aspect, the periodically transmitted message enables a determination of a presence of the wireless device. In another aspect, the message is a schedule announcement or a data frame. In another aspect, the wireless device may be further configured to determine that an originator of the NDC is inactive on the NDC and to determine to transmit an updated control channel schedule based on the determination that the originator of the NDC is inactive. In another aspect, the wireless device may be configured to determine that the originator of the NDC is inactive by receiving a message from a second wireless device and by determining if the message is received from the originator by comparing a medium access control (MAC) address for a transmitter of the received message with a NAN multicast service group (NMSG) identifier (NMSG-ID). In another aspect, the NMSG-ID is based on an originator MAC address and a session ID. In another aspect, the wireless device may be configured to determine the control channel schedule by receiving the control channel schedule in a schedule announcement and by determining autonomously to utilize the received control channel schedule based on an availability of the wireless device. In another aspect, the wireless device may be configured to determining the control channel schedule by rebroadcasting the control channel schedule based upon the determination to utilize the received control channel schedule. In another aspect, the wireless device may be further configured to determine that an originator of the NDC is inactive on the NDC, to receive at least one control channel schedule, and to select one of the at least one control channel schedule. In an aspect, the selection is based on timing information, a medium access control (MAC) address, or a status value. In another aspect, the wireless device may be further configured to receive at least one schedule announcement for a control channel of the NDC from a plurality of wireless devices during a schedule time period. Each schedule announcement includes a corresponding control channel schedule and an indicator. In another aspect, the schedule time period may include one or more multiples of a lifetime value associated with the control channel schedule. In another aspect, the schedule time period is indicated during an NDC setup, is a property of the NDC, is a property of the NAN, or is defined in a NAN standard. In another aspect, the schedule time period is indicated in a schedule update message. In another aspect, the at least one schedule announcement is received one or more discovery windows before the end of the schedule time period. In another aspect, the wireless device may be further configured to transmit a second schedule announcement based on the received at least one schedule announcement. The second schedule announcement may include a second control channel schedule and a second indicator, and the second control channel schedule may be based on a link quality of the determined control channel schedule. In another aspect, the second indicator may indicate a higher schedule quality than indicators in the received at least one schedule announcement. In another aspect, the second indicator may be based on at least one of a timing synchronization function, a medium access control (MAC) address, a schedule quality indicator, a NAN master rank, or a service assigned value. In another aspect, the wireless device may be further configured to select, during the schedule time period, a second control channel schedule, based on the received at least one schedule announcement, for communicating the control information at a beginning of a next schedule time period. In another aspect, the selection may be based on the indicator included in each schedule announcement, and the wireless device may be further configured to rebroadcast the second control channel schedule. In another aspect, the wireless device may be configured to determine the control channel schedule by receiving a plurality schedule announcements from a plurality of wireless devices and by identifying a subset of the plurality of schedule announcements that are compatible with an availability of the wireless device. The control channel schedule may be based on the identified subset. In another aspect, the wireless device may be further configured to transmit a schedule announcement indicating the availability of the wireless device. In another aspect, the wireless device may be configured to determine the control channel schedule by identifying one or more inactive periods within the control channel schedule and by updating the control channel schedule based on the identified one or more inactive periods. In another aspect, the wireless device may be configured to determine the control channel schedule by determining a countdown value associated with a schedule request, by repeatedly transmitting the schedule request when the countdown value is greater than zero, in which the schedule request includes the control channel schedule and an indicator, by decrementing the countdown value after each transmission of the schedule request, and by determining if a schedule rejection message is received from another wireless device with a higher priority indicator based on the transmitted schedule request. In another aspect, the indicator is based on at least one of a timing synchronization function, a medium access control (MAC) address, a schedule quality indicator, a NAN master rank, or a service assigned value. In another aspect, the wireless device may be configured to determine the control channel schedule by refrain from transmitting the schedule request if the schedule rejection message is received or by transmit a change schedule message if no schedule rejection message is received and the countdown value is zero. In another aspect, the wireless device may be configured to determine the control channel schedule by receiving a schedule request that includes a requested control channel schedule and an indicator value, by rebroadcasting the requested control channel schedule if the requested control channel schedule is compatible with the wireless device, and by transmitting a schedule rejection message if the requested control channel schedule is unsuitable for the wireless device and the wireless device is associated with a second indicator value that is greater than or equal to the indicator value in the schedule request. In another aspect, the wireless device may be configured to determine the control channel schedule further by receiving a change schedule message that includes the control channel schedule and by rebroadcasting the control channel schedule.

Another aspect of this disclosure provides a wireless device (e.g., a station) for wireless communication. The wireless device may be configured to receive at least one request to become an owner of a multicast schedule from at least one wireless device and to determine whether to change the owner of the multicast schedule based on the received at least one request and a hysteresis value. In another aspect, the hysteresis value may include a time period outside of an ownership epoch, and the owner of the multicast is changed during the ownership epoch. In another aspect, the ownership epoch is periodic or aperiodic. In another aspect, the determination of whether to change the owner is based on a first priority associated with the wireless device and a respective priority associated with the at least one wireless device. In another aspect, the wireless device may be configured to determine whether to change the owner by determining a time when the owner of the multicast schedule last changed, by determining a difference between an expected time of a next ownership change and the determined time when the owner last changed, and by changing the owner of the multicast schedule if the determined difference is greater than the hysteresis value. In another aspect, the hysteresis value is associated with a neighbor awareness network (NAN) data link (NDL) negotiated during NDL setup, is a standard-defined value, is associated with a NAN cluster, or is announced during a schedule change announcement or during an owner change announcement. In another aspect, the hysteresis value is a fixed value or dynamically determined. In another aspect, the wireless device may be further configured to transmit a request to become the owner of the multicast schedule, and the determination may be further based on the transmitted request. In another aspect, the wireless device may be further configured to determine that a previous owner of the multicast schedule is unavailable. The request to become the owner may be transmitted based on the determination that the previous owner is unavailable. In another aspect, the wireless device may be configured to determine that the previous owner is unavailable by transmitting a schedule change request to the previous owner of the multicast schedule and by determining that a response to the schedule change request is not received within a time period.

### BRIEF DESCRIPTION OF THE DRAWINGS

FIG. 1 shows an example wireless communication system in which aspects of the present disclosure may be employed.

FIG. 2A is an exemplary diagram of a NAN cluster.

FIG. 2B is an exemplary diagram of a communication interval in a NAN.

FIG. 3 is a diagram of a series of scheduling time periods in a NAN network.

FIG. 4 is a diagram of a sequence of time slots during which STAs are expected to be awake.

FIG. 5 is a diagram that illustrates a method for assigning indicator values in a lexicographical order.

FIG. 6 are diagrams of methods for using a hysteresis-type mechanism to prevent frequency ownership change.

FIG. 7 shows an example functional block diagram of a wireless device that may perform schedule negotiations within the wireless communication system of FIG. 1.

FIG. 8 is a flowchart of a method for performing many-to-many multicast scheduling by a schedule owner.

FIGS. 9-11 are flowcharts of methods for performing many-to-many multicast scheduling.

FIG. 12 is a functional block diagram of an example wireless communication device that performs scheduling.

### DETAILED DESCRIPTION

Various aspects of the novel systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method, which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices, which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

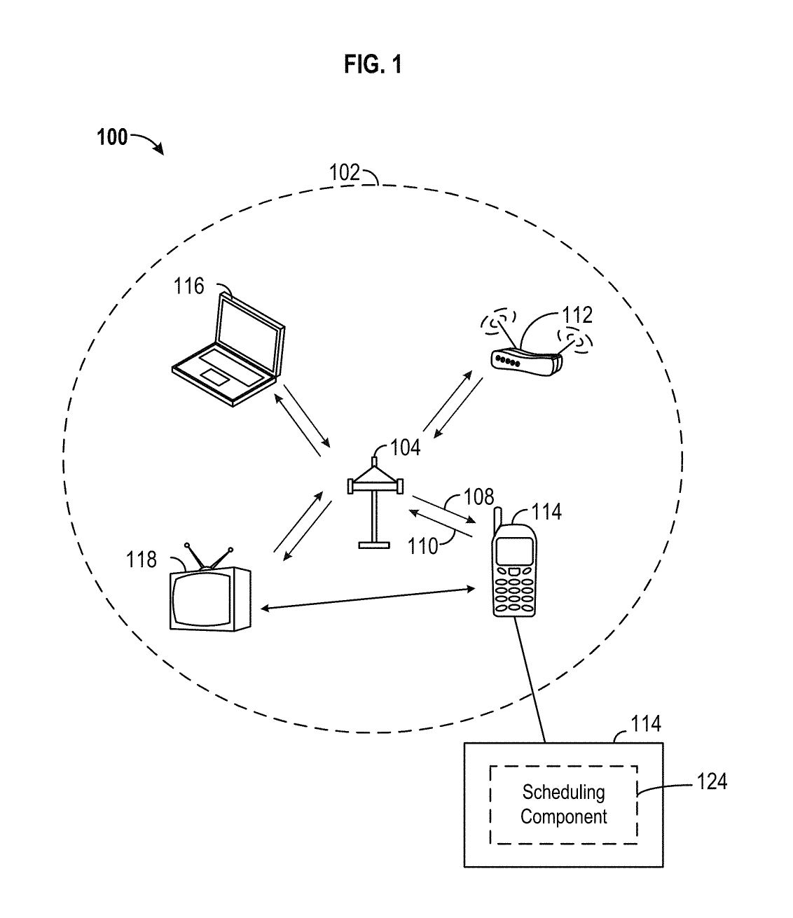

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example.

After receiving the information for associating, either from the beacon or probe response frames, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the STA 114 may include one or more components for performing various functions. For example, the STA 114 may include a scheduling component 124. In one configuration, the scheduling component 124 may be configured to determine a many-to-many multicast schedule for an NDL of a service associated with a NAN network and to communicate with a plurality of wireless devices subscribed to the service based on the determined many-to-many multicast schedule. The apparatus may be a schedule owner of the many-to-many multicast schedule.

In another configuration, the scheduling component 124 may be configured to receive a many-to-many multicast schedule for a NDL of a service associated with a NAN network and to communicate over the NDL based on the received many-to-many multicast schedule.

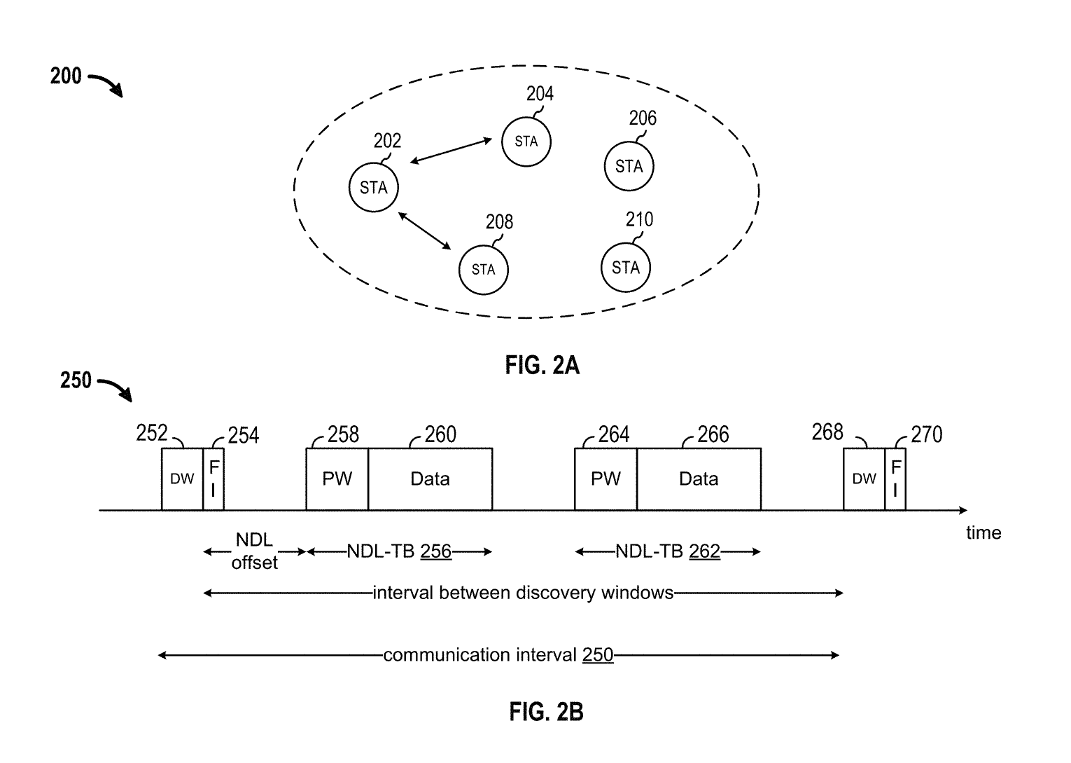

FIG. 2A is an exemplary diagram 200 of a NAN cluster. A NAN cluster (or NAN data cluster) may include multiple wireless devices, such as STAs 202, 204, 206, 208, 210 (or the STAs 112, 114, 116, 118). One or more NAN clusters may make up a NAN network. A NAN cluster may be a collection of NAN devices that share a common set of NAN parameters. NAN parameters may include a time period between consecutive discovery windows, the time duration of the discovery windows, a beacon interval, among others. In an aspect, all of the STAs 202, 204, 206, 208, 210 participating in the NAN cluster may be synchronized to the same NAN clock, which may be determined by the STA 202, for example, if the STA 202 is acting in the anchor master role of the NAN cluster. The STA 202, as the anchor master, may determine the timing synchronization function (TSF) and broadcast the TSF in the NAN synchronization beacon. Other STAs in the NAN cluster may be required to adopt the TSF and to broadcast the TSF to other devices within the NAN. The NAN synchronization beacon may be broadcasted by NAN devices during the discovery window. NAN devices that receive the NAN synchronization beacon may use the beacon for clock synchronization. In another aspect, each wireless device within the NAN cluster may communicate with another wireless device via a device-to-device (D2D) connection. For example, the STA 202 may communicate with the STA 208 via a D2D connection.

FIG. 2B is an exemplary diagram of a communication interval 250 in a NAN. The communication interval 250 may include discovery windows 252, 268 (e.g., NAN service discovery windows which may have 16 time units or 16 ms), which may be time windows designated for and/or dedicated for enabling wireless devices (e.g., a STA) within a NAN to discover other peer wireless devices. That is, during the discovery window 252, for example, wireless devices in the NAN may transmit peer discovery signals, such as NAN service discovery frames, for peer discovery. The discovery window 252 may represent a time period and channel on which the wireless devices in the NAN converge for peer discovery. The time interval between two discovery windows may be 512 time units (e.g., 512 ms). The communication interval 250 may include fixed intervals 254, 270 allocated for connection setup. For example, after wireless devices discover each other during the discovery window 252, the wireless devices may utilize the fixed interval 254 after the discovery window 252 to transmit signaling for a connection setup (e.g., a D2D connection setup). In one aspect, the fixed interval 254 may immediately follow the discovery window 252 and may be dedicated for connection setup. In another aspect, the fixed interval 254 may follow the discovery window 252, but need not immediately follow the discovery window 252.

In an aspect, wireless devices may perform connection setup during the fixed intervals 254, 270. Wireless devices that publish/subscribe to a service may remain awake after the discovery windows 252, 268 to exchange connection setup messages in the fixed intervals 254, 270. In another aspect, wireless devices may perform connection setup during a data link time block (DL-TB) (or another type of time block) in addition to during the fixed intervals 254, 270. As shown in FIG. 2B, the communication interval 250 includes a first NDL time block (NDL-TB) 256 and a second NDL-TB 262. Each NDL-TB may represent a set of time-frequency resources for wireless transmission and/or reception. The first NDL-TB 256 may be offset from the end or beginning of the discovery window 252 by an NDL offset value. The first NDL-TB 256 may include a first paging window 258 and a first data window 260. The first paging window 258 may be used by a first wireless device for paging a second wireless device to indicate that the first wireless device has data to transmit to the second wireless device (e.g., data related to a photo sharing service). Subsequently, the first wireless device may transmit the data in the first data window 260 used for transmitting data associated with destinations/wireless devices identified during the first paging window 258. Similarly, the second NDL-TB 262 may include a second paging window 264 and a second data window 266. In another aspect, if the second wireless device is not paged during a paging window (e.g., no data is expected for the second wireless device), then the second wireless device may enter a sleep or doze state for the remainder of the second NDL-TB 262.

During connection setup, NAN devices may establish a schedule for communicating over an NDL. In one aspect, there may be only one NDL between two NAN devices. A single NDL, however, may support multiple NAN data paths (NDPs) between the two NAN devices. Each NDP may be associated with a different service (e.g., gaming service, photo sharing service, video streaming service, etc.) or a different instance of the same service. In an aspect, each NDP may have its own quality of service and/or security requirements. In another aspect, each NDP may have its own interface. As between the two NAN devices, all of the NDPs between the two NAN devices may conform to the same schedule, which may be the NDL schedule between the two STAs.

In an aspect, an NDL schedule may include a number of repeating NDL-TBs in between a number of repeating DWs. The number of NDL-TBs and DWs may be based on a lifetime of the NDL schedule. In one instance, the repeating NDL-TBs may be on a same channel within a frequency band (e.g., channel X of the 2.4 GHz band). In another instance, the NDL-TBs may be from different channels within a same frequency band (e.g., channel X, Y, and Z of the 2.4 gigahertz (GHz) band). In yet another instance, the NDL-TBs may be from different channels on different frequency bands (e.g., channel X and Y of the 2.4 GHz band and channel Z of the 5 GHz band).

A NAN network provides a mechanism for wireless devices to synchronize time and channel on which the devices may converge to facilitate the discovery of NAN services that have been made discoverable on existing or new devices that enter the NAN. In an aspect, the service discovery may occur without the assistance of an AP. A NAN network may operate in one or more channels of one or more frequency bands (e.g., the sub-1 GHz band, 2.4 GHz band, the 5 GHz band, and/or the 60 GHz band). For example, the NAN network may operate on channel 6 (2.437 GHz) in the 2.4 GHz band and/or optionally in channel 44 (5.220 GHz) or channel 149 (5.745 GHz) of the 5 GHz band. Further, the NDL may operate in one or more channels of one or more frequency bands (e.g., including the sub-1 GHz band, 2.4 GHz band, the 5 GHz band, and/or the 60 GHz band).

NAN communications may be associated with a variety of topologies. In a one-to-one topology, a first NAN device may be communicating over the NAN network only with a second NAN device (e.g., in a text messaging service). In an one-to-many topology, the first NAN device may be communicating with many other NAN devices via multicast or broadcast (e.g., in a file sharing service where a source device transmits files to other devices). In a many-to-many topology, multiple NAN devices may multicast or broadcast data to other NAN devices (e.g., in a multi-user game or a video conference with multiple users connected at different locations) while receiving multicast or broadcast data from the other NAN devices subscribed to the same service.

In a one-to-many multicast, a single device (e.g., a source device or an originator device) may be in control of the data stream, and that device may alter the schedule for communication by sending a frame with a new schedule (e.g., a new multicast schedule in a multicast schedule attribute). In multicast schedules, the originator of the may create the multicast schedule and provide the multicast schedule to enrollees during enrollment. In the one-to-many topology, schedule negotiation may not be allowed with respect to the multicast schedule. The lack of negotiations may be acceptable in one-to-many topologies because a single device is the source of the data.

By contrast, for many-to-many topologies, the ability to negotiate the schedule for communicating may be necessary because devices can be both sources and sinks of multicast or broadcast traffic. As such, it may be beneficial for devices to be able to negotiate scheduling, which may include the size of a time block, a time block interval or periodicity, and/or an NDL operating channel within a frequency band.

Several options for many-to-many multicast scheduling are provided. The options below are described with respect to FIG. 2. Referring to FIG. 2, the STAs 202, 204, 206, 208, 210 may be participants of a NAN service (e.g., a multi-user gaming service). The STA 202 may be the originator of the service; that is, the STA 202 may have initiated the NAN service. The STAs 204, 206, 208, 210 may have subscribed to the NAN service via the STA 202 or via one another STA and be known as subscribers. The STAs 202, 204, 206, 208, 210 may all be associated with the same NAN multicast service group (NSMG) that has an NSMG identifier (ID) (NMSG-ID), and the NMSG-ID may indicate a many-to-many multicast service. In aspect, the NMSG-ID may be based on a device address (e.g., a MAC address), a service identifier, and a random value. Subscribers that join a multicast service may receive the multicast schedule, and common group key associated with the multicast service, and the NMSG-ID. Further, subscribers may become enrollers for the service and enroll other subscribers.

### Option 1—No Schedule Modification

In option 1, no scheduling modification may be allowed. Referring to FIG. 2A, the STAs 204, 206, 208, 210 may join a service provided by the STA 202 and become subscribers. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). Once the STA 202 determines the many-to-many multicast schedule, then neither the STA 202 nor other STAs who join the service can alter the schedule (e.g., the schedule is immutable). The STA 202 may propagate the immutable many-to-many multicast schedule to the STAs 204, 208, which may, in turn, propagate the many-to-many multicast schedule to STAs 206, 210, respectively. In this option, once a device joins the originator of the service, the schedule may be frozen.

### Option 2—Originator is Allowed to Modify Schedule

In option 2, only the originator device (or the STA 202) may be allowed to modify the schedule for the NDL of the service. Referring to FIG. 2A, the STAs 204, 206, 208, 210 may join a service provided by the STA 202. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). After determining the schedule, the STA 202 may broadcast the many-to-many multicast schedule to other devices in a frame (e.g., a service discovery frame, a NAN management frame, or some other frame). The STA 202 may also determine a first timestamp (e.g., a TSF) indicating when the many-to-many multicast schedule was generated or when the frame that includes the many-to-many multicast schedule was transmitted. The first timestamp may be based on the NAN clock of the NAN to which all the STAs 202, 204, 206, 208, 210 may be required to be synchronized. The first timestamp may be included with the transmitted frame. Subsequently, the STA 202 may detect a change in conditions. For example, the STA 202 may detect that the current NDL schedule has poor channel quality (e.g., low signal to interference noise ratio (SINR), a poor channel quality index (CQI), or transmitted signals have a low received signal strength indicator (RSSI) based on feedback from other STAs). The STA 202 may determine that other NDL-TBs have less interference and/or traffic. In another example, the STA 202 may determine that other channels are capable of supporting a higher modulation and coding scheme (MCS). In another example, the battery life of the STA 202 may be diminished, thereby supporting a fewer number of scheduled transmissions. Due to a change in any number of conditions, the STA 202 may adjust the many-to-many multicast schedule. The STA 202 may transmit the adjusted many-to-many multicast schedule in a frame that includes a second timestamp based on when the many-to-many multicast schedule was adjusted or transmitted. Devices, such as the STAs 204, 208, that receive the frame may determine that the frame includes an updated schedule by comparing the second timestamp in the message to the first timestamp of the previously received message. The STAs 204, 208 may adopt the adjusted many-to-many multicast schedule and propagate or rebroadcast the adjusted many-to-many multicast schedule to others STAs (e.g., the STAs 206, 210).

In an aspect, any of the transmitted messages in this option may include the NMSG-ID, indicating that a many-to-many multicast schedule is provided. In one embodiment, the NMSG-ID may be based on the MAC address of the originator device (the STA 202) and a session ID associated with the service. As such, when the STAs 204, 206, 208, 210 receive a message, the STAs 204, 206, 208, 210 may be able to determine whether the STA 202 transmitted the message.

### Option 3—Schedule Modification Request

In option 3, the originator device (or the STA 202) may be allowed to modify the schedule for the NDL of the service. However, unlike in option 2, the originator device may also determine to modify the schedule based on a subscriber request (e.g., a request from one or more of the STAs 204, 206, 208, 210). That is, the STA 202 may determine to modify the many-to-many multicast schedule on its own or in response to a subscriber's request.

Referring to FIG. 2A, the STAs 204, 206, 208, 210 may join a service provided by the STA 202. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). After determining the schedule, the STA 202 may broadcast the many-to-many multicast schedule to other devices in a frame (e.g., a service discovery frame, a NAN management frame, or some other frame).

Due to a change in conditions, including those mentioned with respect to option 2, a subscriber may request that the STA 202 adjust the many-to-many multicast schedule. The request may be transmitted in a NAN management frame, or any other frame, outside of or during a discovery window of the NDL. Referring to FIG. 2A, the STA 210 may determine that the RSSI of the data received from the STA 202 is below a threshold and transmit request to the STA 202, requesting that the STA 202 adjust the many-to-many schedule. The STA 208 may receive the request from the STA 210 and rebroadcast the request. Other STAs in the NAN, except for the originator of the service, may also rebroadcast the request. In one aspect, the request may include suggested parameters for adjusting the schedule (e.g., different NDL-TB sizes, different NDL-TB periodicity, or a different operating channel). In this aspect, upon receiving the request, the STA 202 may take the suggested parameters into consideration when determining whether to modify the schedule. For example, the STA 202 may determine whether the STA 202 is available according to the suggested parameters. If so, the STA 202 may incorporate the suggested parameters into the modified many-to-many schedule. Alternatively, the STA 202 may utilize parameters different from the current parameters of the many-to-many multicast schedule. In another aspect, the request may not include suggested parameters for modifying the many-to-many multicast schedule. In this aspect, the STA 202 may determine parameters for modifying the many-to-many schedule based on a number of conditions (e.g., network conditions, device conditions, etc.). In another aspect, the STA 202 may ignore a request to change the many-to-many multicast schedule and keep the same schedule. In another aspect, the STA 202 may determine to change the many-to-many multicast schedule after a threshold number of requests have been received. The threshold number of requests may be based on a number of subscribers to the service (e.g., threshold number of requests may be a percentage, and the number of requests should exceed a threshold percentage number of subscribers such as 50%). Assuming the STA 202 adjusts the many-to-many multicast schedule, the STA 202 may transmit (or broadcast) the adjusted many-to-many multicast schedule in a frame to the STAs 204, 208. The STAs 204, 208, upon receiving the frame, may also propagate or rebroadcast the adjusted many-to-many multicast schedule to others STAs (e.g., the STAs 206, 210).

In an aspect, the frame indicating the adjusted many-to-many schedule may include an NMSG-ID, indicating that a many-to-many multicast schedule is provided. The NMSG-ID may be based on the MAC address of the originator device (the STA 202) and a session ID associated with the service. As such, when the STAs 204, 206, 208, 210 receive a message, the STAs 204, 206, 208, 210 may be able to determine whether the STA 202 transmitted the message. In another aspect, besides the NMSG-ID, another flag may be used to indicate that the many-to-many multicast schedule is provided.

In sum, under option 3, only the originator device may change the many-to-many multicast schedule. However, the originator device may initiate the change on its own or at the request of one or more subscribers to the service.

### Option 4—any Device is Allowed to Modify the Schedule

In option 4, any device (including the originator, the STA 202, or the subscriber, the STA 204) may be allowed to modify the schedule for the NDL of the service. Referring to FIG. 2A, the STAs 204, 206, 208, 210 may join a service provided by the STA 202. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). After determining the schedule, the STA 202 may broadcast the many-to-many multicast schedule to other devices in a frame (e.g., a service discovery frame, a NAN management frame, or some other frame).

The STAs 202, 204 may communicate based on the many-to-many multicast schedule determined by the STA 202. Subsequently, the STA 204 may detect a change in conditions. For example, the STA 204 may detect that the current NDL schedule has poor channel quality (e.g., low SINR, a poor CQI, or received signals have an RSSI below a threshold). The STA 204 may determine that other NDL-TBs have less interference and/or traffic. In another example, the STA 204 may determine that other channels are capable of supporting a higher MCS. In another example, the battery life of the STA 204 may be diminished, thereby requiring a fewer number of schedule transmissions. Due to a change in any number of conditions, the STA 204 may adjust the many-to-many multicast schedule. The STA 204 may transmit the adjusted many-to-many multicast schedule in a frame (e.g., a schedule announcement frame). Devices, such as the STAs 202, 206, that receive the frame may respectively determine whether the adjusted many-to-many multicast schedule is suitable or compatible with the availability and/or the device characteristics of the STAs 202, 206. If so, then the STAs 202, 206, for example, may determine autonomously to utilize the adjusted schedule; otherwise, the STAs 202, 206 may determine not to utilize the schedule. If the STAs 202, 206 determine to utilize the schedule, the STAs 204, 208 may propagate or rebroadcast the adjusted many-to-many multicast schedule to others STAs (e.g., the STAs 208, 210).

### Option 5—Schedule Modification Based on Priority

In option 5, any device (include the originator, the STA 202, or the subscriber, the STA 204) may be allowed to transmit a proposed many-to-many multicast schedule for the NDL of the service. The proposed schedule may be transmitted with an indicator that enables devices receiving the schedule to select from among a number of proposed many-to-many schedules received from other devices.

Referring to FIG. 2A, the STAs 204, 206, 208, 210 may join a service provided by the STA 202. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). After determining the schedule, the STA 202 may broadcast the many-to-many multicast schedule to other devices in a frame (e.g., a service discovery frame, a NAN management frame, or some other frame).

The STAs 202, 204, 206, 208, 210 may communicate based on the many-to-many multicast schedule determined by the STA 202. Subsequently, the STAs 204, 206, 208, 210 may detect a change in conditions. For example, the STAs 204, 206, 208, 210 may detect that the current NDL schedule has poor channel quality (e.g., low SINR, a poor CQI, or received signals have an RSSI below a threshold). The STAs 204, 206, 208, 210 may determine that other NDL-TBs have less interference and/or traffic. Due to a change in any number of conditions, the STAs 204, 206, 208, 210 may determine a proposed many-to-many multicast schedule. The STA 204, 206, 208, 210 may transmit the proposed many-to-many multicast schedule in a frame (e.g., a schedule announcement frame). The proposed many-to-many multicast schedule may be transmitted with an indicator that is associated with a priority in which the proposed many-to-many schedule may be adopted by other devices. In an aspect, the indicator may be a function of a status of the device transmitting the proposed schedule. For example, if the STA has a large number of connections and is only available during a more limited schedule, then the STA may be given a higher priority with which the proposed schedule may be adopted. In another example, if the STA has limited battery life remaining, the STA may be given a lower priority than another device with a greater amount of battery life. In another aspect, the indicator may be based on at least one of a TSF, a MAC address, a schedule quality indicator, a NAN master rank, or a service assigned value. For example, STAs that transmit a proposed schedule earlier may have a higher priority indicator based on an earlier TSF than STAs that transmit a proposed scheduler at a later time. STAs with a lower MAC address value may have a higher priority indicator (or vice versa). STAs may indicate their schedule quality (e.g., based on previous measurements on the resources), and STAs with higher schedule quality may have a higher priority. STAs in a NAN may have a NAN master rank. The master rank may be based on a preference of the STA to serve as a NAN master, a random factor, and/or a NAN interface address. A service assigned value may be a value assigned by the service to which the STA is subscribed. The service assigned value may be assigned based on criteria unique to the service. For example, a multi-user gaming service may assign users who have certain characters, roles, or game items a higher priority than others. In sum, the indicator may be based on one or more of the foregoing factors.

After the STAs transmit their respective proposed schedules and indicators, each of the devices may receive the various schedules and indicators and determine which proposed schedule, if any, to accept or adopt. In one aspect, the STAs may determine if the STAs are available during some or all of the time slots indicated in each proposed schedule. Each STA may select a schedule for which is most suitable for the STA based on availability. In an aspect, the schedule selection may also be determined based on the indicator included with the proposed schedule. For example, if the STAs' availability with respect to two or more schedules are similar, the STA may choose the schedule that is associated with an indicator of a higher priority. After selecting a proposed many-to-many multicast schedule, the STA may propagate or rebroadcast the adjusted many-to-many multicast schedule to others STAs.

In sum, under option 5, STAs may autonomously schedule changes based on a weighted arbitration from the indicators. STAs in the multicast group may be allowed to transmit a new, proposed schedule with a self-assigned or out-of-band weight (service assigned value). Out-of-band refers to the weight being assigned out of a NAN specified protocol. STAs that hear the schedule may autonomously move to the schedule of the highest weight received. As previously discussed the weight may be a function of a constraints on the STA as well as other factors. A device that moves to the new schedule may rebroadcast the new schedule.

### Option 6—Periodic Messaging

In option 6, the originator device (or the STA 202) may periodically transmit messages to indicate the presence of the originator device in the NDL. Alternatively, if the originator device is inactive, another device that has assumed the scheduler role may periodically transmit messages to indicate the presence of the scheduler in the NDL. The periodic messages may function as a heartbeat indicating the presence of a device with the scheduler role. The messages may include a schedule announcement or simply indicate that the device is participating in the NDL (e.g., a data transmission associated with the service over the NDL). For example, the messages may be a service discovery frame transmitted during a NAN discovery window, a NAN action frame (with integrity protection check) during a discovery window or a further availability window. In another aspect, the message may be a frame transmitted during a NAN paging window or transmission window. In another aspect, the messages may be transmitted within the lifetime of a many-to-many multicast schedule for the NDL. In another aspect, the messages may include an NMSG-ID, and other devices receiving the messages may utilize the NMSG-ID to determine that the messages were transmitted by the originator device or another device with the scheduler role.

Referring to FIG. 2A, the STAs 204, 206, 208, 210 may join a service provided by the STA 202. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). After determining the schedule, the STA 202 may periodically broadcast the many-to-many multicast schedule to other devices in a frame (e.g., a service discovery frame, a NAN management frame, or some other frame) and/or may periodically transmit data frames to other devices associated with the NDL. Each of the frames may include an NMSG-ID.

In this option, the STA 202 may be allowed to modify the schedule, if needed, or continue with the current many-to-many multicast schedule if the schedule satisfies the service needs. If the STA 202 misses a periodic message transmission (e.g., the STA 202 moves to a different area, is out of battery, or any other reason), however, any other STA may take ownership of the schedule maintenance. For example, the STAs 204, 208 may determine that the STA 202 is inactive by determining that the STA 202 missed one or more periodic transmissions. Although the STAs 204, 208 may receive other messages associated with the service, the STAs 204, 208 may determine that those messages are not associated with the STA 202 based on the NMSG-ID.

Because the STA 202 is inactive, the STAs 204, 208 may determine an updated many-to-many multicast schedule based on conditions at the STAs 204, 208 and broadcast the updated many-to-many multicast schedule. Similarly, the STAs 206, 210 may also determine that the STA 202 is no longer active in the NDL. The STAs 206, 210 may receive the updated many-to-many multicast schedules from the STAs 204, 208 and autonomously determine whether the STAs 206, 210 are available for the schedule indicated in the broadcast from the STAs 204, 208. If both schedules are suitable for the STAs 206, 210, then the STAs 206, 210 may select one of the two schedules based on an indicator, which may be included with each of the schedules. For example, the indicator may be based on a TSF, a MAC address, or some other factor. The STAs 206, 210 may select, for example, the first schedule to be received, the schedule transmitted by a device with a lowest MAC address, or with the highest priority. The STAs 206, 210 are free to leave the NDL if the current or updated schedules are incompatible with the STAs 206, 210. If the STAs 206, 210 leave the NDL, the STAs 206, 210 may form a different group with other STAs interested in the service. If the STAs 206, 210 accept the updated many-to-many multicast schedule, then the STAs 206, 210 may rebroadcast the updated schedule.

### Option 7—Schedule Modifications Based on Lifetime

A many-to-many multicast schedule may be associated with a lifetime or lifetime value (e.g., a number of NDL-TBs, a number of communication intervals, etc.). The lifetime may be indicated during NDL setup, may be a property of the NAN service, or may be defined in the NAN standard. In option 7, a schedule change may be permitted at the end of a schedule time period (or schedule epoch), which may include one or more lifetime values. The schedule time period or schedule epoch may be indicated in a schedule update message.

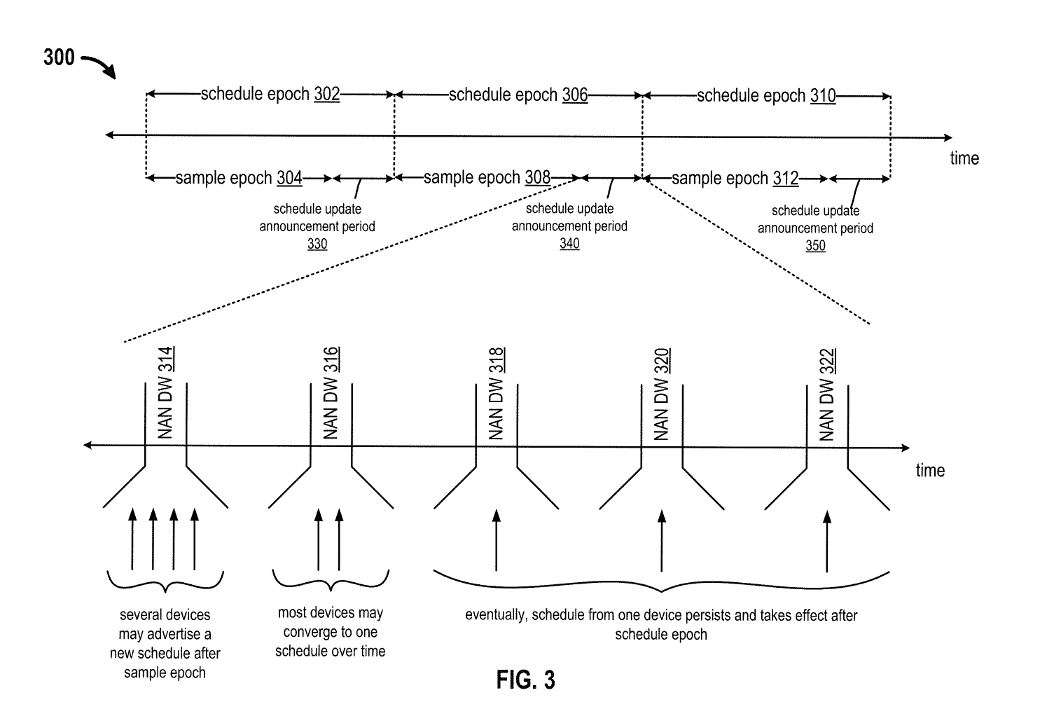

FIG. 3 is a diagram 300 of a series of scheduling time periods in a NAN network. Referring to FIG. 3, a service may be associated with a first schedule epoch 302, a second schedule epoch 306, and a third schedule epoch 310. Each schedule epoch may include a sample epoch, which may represent a time period for devices to sample the NDL and determine whether the current schedule of the NDL is compatible with the device or whether the schedule has poor quality. After sampling the schedule epoch, devices may have a time window during which to announce and receive schedule updates. For example, the first schedule epoch 302 may have a first sample epoch 304 and a first schedule update announcement period 330. The second schedule epoch 306 may include a second sample epoch 308 and a second schedule update announcement period 340. The third schedule epoch 310 may include a third sample epoch 312 and a third schedule update announcement period 350. As shown in FIG. 3, each schedule update announcement period may include one or more NAN DWs. In FIG. 3, the second schedule update announcement period 340 following the second sample epoch 308 includes a first NAN DW 314, a second NAN DW 316, a third NAN DW 318, an fourth NAN DW 320, and a fifth NAN DW 322. Another number of NAN DWs may also be present.

In option 7, any device (including the originator, the STA 202, or the subscriber, the STA 204) may be allowed to modify the many-to-many multicast schedule regardless of whether the originator device (e.g., the STA 202) is active in the service. The new schedule may be transmitted in a service discovery frame, a NAN management frame, or some other frame associated with the NDL. If there is no change in the schedule, the originator and other devices may announce the current schedule.

Referring to FIG. 2A, the STAs 204, 206, 208, 210 may join a service provided by the STA 202. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). After determining the schedule, the STA 202 may broadcast the many-to-many multicast schedule to other devices in a frame (e.g., a service discovery frame, a NAN management frame, or some other frame).

The STAs 202, 204, 206, 208, 210 may communicate based on the many-to-many multicast schedule determined by the STA 202. Referring to FIG. 3, during the second sample epoch 308, the STAs 204, 206, 208, 210 may sample the quality of the NDL based on the current many-to-many multicast schedule. For example, the STAs 204, 206, 208, 210 may determine the CQI of the channel(s) associated with the schedule for the NDL and/or measure the SINR and/or the RSSI of packets received based on the schedule. Based on the sampling, the STAs 204, 206, 208, 210 may determine whether to determine a different many-to-many multicast schedule and transmit the schedule during the second schedule update announcement period 340 following the second sample epoch 308. In an aspect, one or more of the STAs 204, 206, 208, 210, and other STAs associated with the NDL, may determine to transmit a new many-to-many multicast schedule after the second sample epoch 308. The new schedules may be transmitted n DWs before the end of the second schedule epoch 306, where n is a non-zero integer greater than or equal to 1. For example, in a first NAN DW 314, the STAs 204, 206, 208, 210 may each advertise a new schedule for the third schedule epoch 310. In an aspect, the many-to-many multicast schedules may be transmitted with an indicator. As discussed above, in an aspect, the indicator may be a numerical value representing a schedule quality from the point of view of the each advertising STA. In another aspect, the indicator may be associated with a scheduling priority of the STA (e.g., a device with a higher scheduling priority is more likely to have the proposed schedule selected).

In the second NAN DW 316, the STAs may converge to an advertised schedule over time. As shown in the second NAN DW 316, some of the STAs converged to a schedule previously advertised in the first NAN DW 314, and two STAs continue to announce their respective proposed schedules (e.g., the STAs 204, 206). In the third NAN DW 318, all STAs have converged onto a single many-to-many multicast schedule. The schedule that the other STAs have selected may be rebroadcasted by the STAs that have selected the schedule. As shown in FIG. 3, in the third, fourth, and fifth NAN DWs 318, 320, 322, only a single schedule is being announced (e.g., the schedule of the STA 204). At the end of the second schedule epoch 306, the STAs 202, 204, 206, 208, 210 may use the newly selected schedule for communicating in the third schedule epoch 310. This process may be repeated in all schedule epochs for any number of schedule epochs.

### Option 8—Autonomous Schedule Updates

Option 8 provides a mechanism in which STAs may gradually adapt to a new many-to-many multicast schedule. Under this option, each STA may assess its local conditions and propose (or announce) a schedule with transmit time blocks (e.g., NDL-TBs) during which each STA is available and may transmit data. If the schedule, comprised of the time blocks, is suitable for a neighboring STA, then the neighboring STA may incorporate the announced schedule into its own schedule. Over time, STAs may move to a new schedule that includes time blocks compatible with other STAs, while time blocks that are not being used by anyone may expire and get dropped or deleted from the schedule.

In this option, every STA C may maintain three variables: S_all(C), S_union(C), and S_self(C). S_self(C) may represent schedules computed or preferred by the STA C, which may include the STA C's desired transmission schedule. S_union(C) may represent the union of all schedules received by STA C. S_all(C) may represent the times the STA C is awake (e.g., to listen and/or to transmit). S_all(C) may be updated when another STA sends an updated schedule.

Referring to FIG. 2A, the STA 202 may determine S_self(202) and transmit S_self(202). The STA 204 may receive S_self(202). The STA 204 may also receive S_self(206). If S_self(202) and S_self(206) are both compatible with the STA 204, then the STA 204 may combine S_self(202) and S_self(206) into S_union(204). The STA 204 may also determine S_self(204) and combine S_self(204) with S_union(204) to form S_all(204). Subsequently, other STAs 208, 210 may also transmit S_self(208) and S_self(210), respectively. If S_self(208) and S_self(210) are compatible with the availability of the STA 204, then the STA 204 may update S_union(204) to include S_self(208) and S_self(210), which may also cause an update to S_all(204). Other STAs 206, 208, 210 may also create a respective S_all(206), S_all(208), S_all(210). Subsequently, each of the STAs may send updated S_self( ) schedules that may include different time blocks. Inactive slots may be removed and new slots may be added. As such, as the schedules propagate through the network, S_all( ) for each respective STA may also be updated to remove inactive slots in the S_all( ) and S_union( ).

### Option 9—Implicit Consensus Based Schedule Update

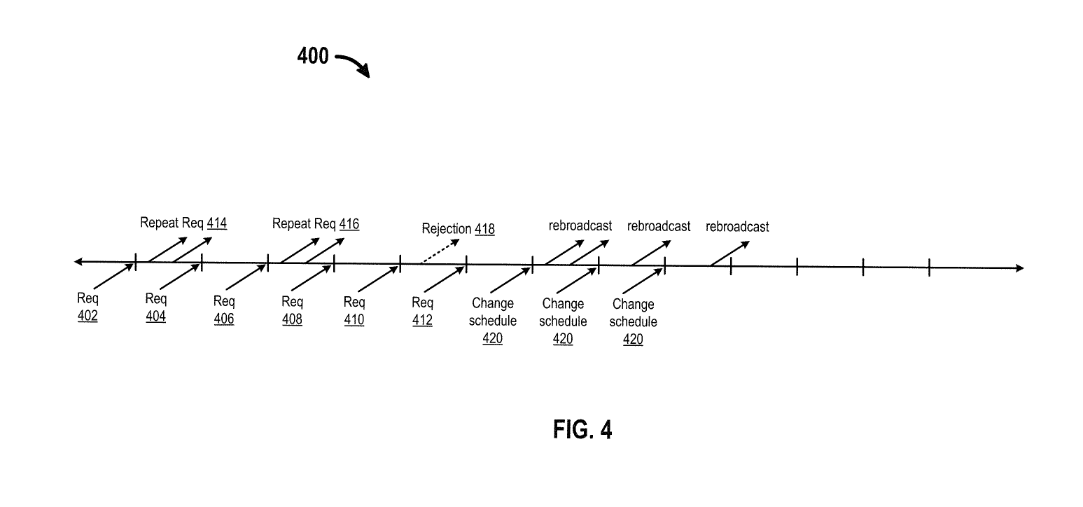

In NAN, or other wireless networks, STAs may be required to be awake at certain times. FIG. 4 is a diagram 400 of a sequence of time slots during which STAs (e.g., the STAs 202, 204, 206, 208, 210) are expected to be awake. In an aspect, the time slots may correspond to a sequence of discovery windows as shown in FIG. 2B. Alternatively, the slots may correspond to NDL-TBs or other time blocks. In this option, each STA may be associated with an indicator value. The originator of the service may have an indicator value (IV), which may be a priority value for schedule modification that allows for arbitration between STAs. In another aspect, the IV may also be referred to as a NMSG schedule rank. A number of schemes may be used to determine the indicator value.

In a first scheme, the indicator value of a STA may be a function of the indicator value of the STA's enroller. For example, a STA that originates a service may have an IV=0. Subsequent STAs, such as STA A, that join the service may have an indicator value determined by the following equation: IV(STA A)=IV(Enroller of STA A)+1. For example, assuming the STA 202 is the originator, then the STA 202 has an IV=0. If the STA 202 enrolls the STAs 204, 208, then the STAs 204, 208 have an IV=1. If the STAs 204, 208 each enroll STAs 206, 210, respectively, then the STAs 206, 210 have IV=2 (e.g., IV(206)=IV(204)+1).

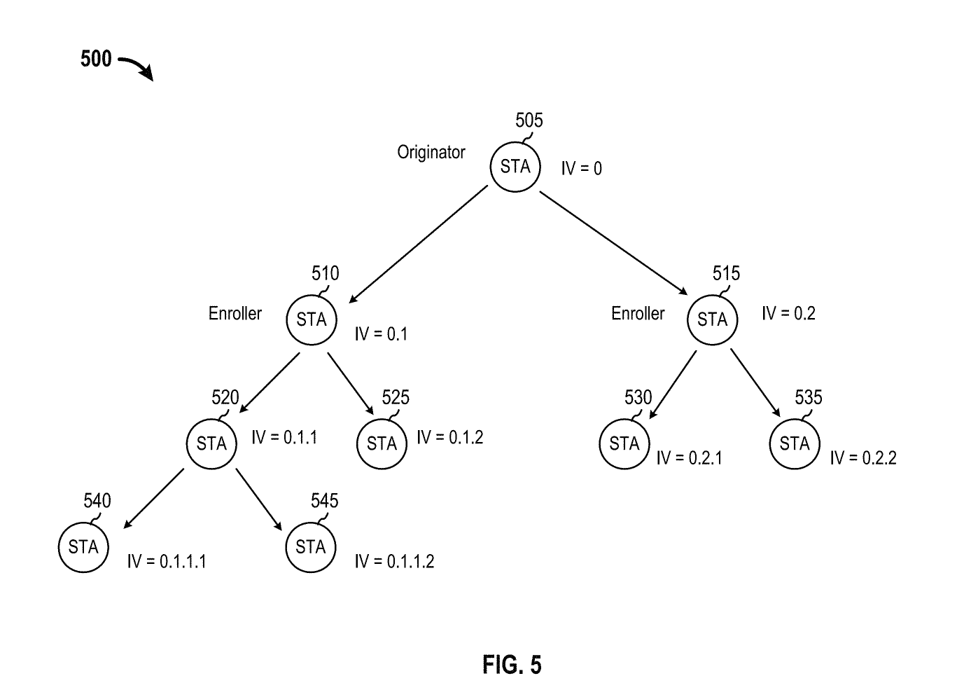

In a second scheme, the indicator value may be a priority value assigned in a lexicographical order. FIG. 5 is a diagram 500 that illustrates a method for assigning indicator values in a lexicographical order. As shown in FIG. 5, the IV in this scheme is a combination of a depth of the STA in the “enroll” tree and a time at which the STA joins. Referring to FIG. 5, the STA 505 may be an originator of a service and have an IV=0. The STA 505 may enroll STAs 510, 515, and the STA 510 may have an IV=0.1 and the STA 515, having joined after the STA 510, may have an IV=0.2. Subsequently, STAs 510, 515 may become enrollers. The STA 510 may enroll the STAs 520, 525, and the STA 520 may have an IV=0.1.1, and the STA 525, having joined after the STA 520, may have an IV=0.1.2. Similarly, the STA 515 may enroll STAs 530, 535, and the STA 530 may have an IV=0.2.1, and the STA 535, having joined after the STA 530, may have an IV=0.2.2. The STA 520 may also become an enroller and enroll STAs 540, 545. The STA 540 may have an IV=0.1.1.1, and the STA 545 may have an IV=0.1.1.2.

In the second scheme, STAs on a higher level may have a higher priority. For example, the STA 530 with an IV=0.2.1 has a higher priority than STA 540 with an IV=0.1.1.1. STAs on a higher level have a shorter lexicographical priority value (or IV) than STAs on a lower level. For example, STA 530 with an IV=0.2.1 has a shorter IV value than STA 540 with an IV=0.1.1.1. If STAs are on the same level, then the STA with the lesser or smaller lexicographical priority value may have greater priority. For example, the STAs 520, 525, 530 are on the same level, and therefore, have the same lexicographical priority value length (or string length). The STA 520 has an IV=0.1.1, the STA 525 has an IV=0.1.2, and the STA 530 has an IV=0.2.1. Because 0.2.1>0.1.2>0.1.1, the STA 520 has a higher priority than the STA 525, which has a higher priority than the STA 530. In this aspect, the STA with the smaller or lesser lexicographical priority value has the higher priority. In another aspect, the STA with the bigger or greater lexicographical priority value may have the higher priority. In an aspect, in the first and second schemes, if the enroller of the STA leaves the NAN network, the IV of the STA need not change.

In sum, as shown in FIG. 5, STAs at a lower depth of the “enroll” tree may have a lower rank than STAs of a higher depth. For STAs at the same level of the tree, the rank may be based on the lexicographical ordering (e.g., rank(0.2)>rank(0.1.1), and rank(0.1.1)>rank(0.2.1)).

In a third scheme, the indicator value may be a combination multiple values. For example, the indicator value may be based on a concatenation of a number of enrollees (A), an age or a length of time that the wireless device has been in the NAN network (B), a preference parameter set by a service or an application (C), and a random number (D), such that IV=A|B|C|D. In this example, the service or application may determine the preference parameter (C) on a per user basis. In one aspect, if the service is a gaming service, then users with a higher rank in the game may be allocated a higher preference parameter. In another aspect, users who pay for the service may be allocated a higher preference parameter than users who do not pay for the service. In some instances, users may have the same values for A, B, and C. Therefore, In this scheme, a higher numerical value for the IV may indicate a higher priority.

In option 9, any STA associated with NDL may modify the many-to-many multicast schedule for the NDL unless another STA of equal or higher indicator value rejects the proposed modification. Referring to FIG. 2A, the STAs 204, 206, 208, 210 may join a service provided by the STA 202. The STAs 202, 204, 206, 208, 210 may be associated with a NAN multicast service group, and any device within the service group may request a schedule change. The STA 202 may initiate the service by determining the many-to-many multicast schedule for an NDL associated with the service. The STA 202 may determine the many-to-many multicast schedule based on an availability of the STA 202, the requirements of the service (e.g., quality of service requirements associated with the service), and/or preconfigured information related to the service (e.g., default scheduling requirements associated with services within a NAN network). After determining the schedule, the STA 202 may broadcast the many-to-many multicast schedule to other devices in a frame (e.g., a service discovery frame, a NAN management frame, or some other frame).

The STAs 202, 204, 206, 208, 210 may communicate based on the many-to-many multicast schedule determined by the STA 202. Subsequently, the STA 204, for example, may detect a change in conditions. The STA 204 may detect that the current NDL schedule has poor channel quality (e.g., low SINR, a poor CQI, or received signals have an RSSI below a threshold). The STA 204 may determine that other NDL-TBs have less interference and/or traffic. Due to a change in any number of conditions, the STA 204 may determine a proposed many-to-many multicast schedule. Further, the STA 204 may determine a countdown value associated with the proposed many-to-many multicast schedule. The countdown value may be preconfigured within the STA 204 or determined based on other factors. The countdown value may represent a number of times the STA 204 will transmit the proposed many-to-many multicast schedule in a schedule request for purposes of requesting other STAs associated with the NDL to adopt the many-to-many multicast schedule. For example, referring to FIG. 4, the countdown value may be set to 6.

After determining the countdown value associated with the schedule request, the STA 204 may transmit the proposed many-to-many multicast schedule in a first schedule request frame 402 (e.g., a NAN management frame). The first schedule request frame 402 may be transmitted during a time slot in which all the STAs associated with the service are expected to be awake (e.g., a discovery window). In an aspect, each schedule request frame may include the IV associated with the transmitting STA. With each transmission, the countdown value may be decremented by 1. The STA 204 may repeatedly transmit the proposed many-to-many multicast schedule in a second, third, fourth, fifth, and sixth schedule request frames 404, 406, 408, 410, 412 until the countdown value is 0 or until another STA rejects the schedule request. In an aspect, the first schedule request frame 402 may be transmitted in a separate message or may be included in a beacon that the STA 204 transmits in an NDC control channel for synchronization. In another aspect, the first schedule request frame 402 may be encrypted using the CGK associated with the NDL.

STAs that receive the schedule request frames may retransmit or repeat the schedule request frames if the STAs are available during the proposed schedule (e.g., repeated schedule request frames 414, 416). The repeated schedule request frames may include the address of the STA 204, for example, and the IV of the STA 204. In an aspect, the retransmitted request frames may be in a separate message or may be included in a beacon that the STAs transmit in an NDC control channel for synchronization. In another aspect, STAs with an equal or higher IV than the STA 204 may reject the proposed schedule change. Referring to FIG. 2A, STA 208 has the same IV as the STA 204, and the STA 202 has a higher IV than the STA 204; therefore, either the STA 202 or the STA 208 may determine to reject the schedule change if the proposed many-to-many multicast schedule is unsuitable for either of the STAs 202, 208. In this aspect, the originator device may reject any schedule change and other devices may not reject a schedule change proposed by the originator. The STAs 202, 208 may reject the proposed schedule by transmitting a rejection message 418. In an aspect, the rejection message 418 may be encrypted using the CGK associated with the NDL. In another aspect, if a STA is allowed to reject the proposed schedule, then the STA may explicitly or implicitly reject the proposed schedule change. For example, the STA 202 may explicitly reject the proposed schedule change by sending the rejection message 418 via unicast to the STA 204 that requested the schedule change, and the rejection message 418 may indicate that the proposed schedule change is rejected. In another example, if the STA 202 received the schedule change request via the STA 208, then the STA 202 may send the rejection message 418 to the STA 208, and the rejection message 418 may indicate the address of and the proposed schedule change from the STA 204. The STA 208 may transmit or relay the reject message to STA 204, indicating the IV of the STA 202. In another example, if the STA 202 receives schedule change request from both the STA 204 and the STA 208, then the STA 202 may transmit the rejection message 418 only to STA 204. In another example, the STA 202 may transmit a multicast reject message in response to the schedule change request from the STA 204. In this example, other devices may repeat the multicast reject messages, either via unicast or multicast, in the same way that schedule request messages are repeated. In another example, the STA 202 may implicitly reject the proposed schedule change by sending a message with a different proposed schedule than the schedule proposed by the STA 204. Other devices that receive the implicit rejection may rebroadcast the implicit rejection. In an aspect, the message may be a channel change message with a different proposed schedule. If the STA 204 receives the rejection message 418 (either implicit or explicit), the STA 204 may stop repeating the schedule change request and the schedule need not change based on the request from the STA 204. In an aspect, because other devices do not see the countdown to zero, a schedule change does not occur. In another aspect, the rejection message 418 may be rebroadcasted only by enrollers in the NAN. In this aspect, the number of broadcasters is limited. And even if the rejecting device's enroller has moved away, another enroller device may be available to rebroadcast and propagate the rejection message 418 to the device that initiated the schedule change. In another aspect, only enrollers in the service may forward the rejection message 418 to the STA that transmitted the schedule request. In this aspect, the rejection message may not be broadcasted, but rather unicasted at each hop. If a STA has lost the connection with its enroller or the enroller has moved away, then the STA may establish a new connection with a nearest enroller. Such unicast transmissions may be secure and protected via a pairwise key established between the STA and its enroller (e.g., if the link between the STA and its enroller or the nearest enroller is secure).

If the STA 204 sends out the sixth schedule request frame 412 and does not receive a rejection message, then, at a subsequent slot, the STA 204 may transmit a change schedule message 420. In an aspect, the change schedule message 420 may include an indication of time (e.g., a TSF or a discover window number) for when the schedule change will occur. In another aspect, the change schedule message 420 may be encrypted with the CGK associated with the NDL. STAs that receive the change schedule message (e.g., the STA 208) may repeat or rebroadcast the change schedule message 420. STAs that receive the change schedule message 420 may change their schedule to the proposed many-to-many multicast schedule as provided by the STA 204. In an aspect, the STAs that receive the change schedule message 420 may change to the new schedule at the specified time indicated in the change schedule message.

In an aspect, some or all of the foregoing transmissions may be encrypted using a common group key (CGK). The CGK may be a key used for group communications between members of the NDL for the multicast service. The CGK may be used by all STAs associated with the same service or the same instance of the same service. All STAs that have joined the service may know the CGK, which may be provided initially by the originator device. The CGK may be used to encrypt and decrypt all group communications associated the service for added security. In an aspect, the CGK may also be known as a group master transient key (MTK) or NMSG MTK.

Although the foregoing options for scheduling negotiation have been described with respect to many-to-many multicast scheduling for data transmission, all of the concepts, techniques, and methods described in the various options may also apply for determining a schedule for exchanging control information, as opposed to data, within a data cluster, such as a NAN data cluster (NDC), which may include many one-to-one links, many one-to-many links, and/or many many-to-many links between devices. That is, an NDC may include a combination of one-to-one, one-to-many, and many-to-many links with some STAs participating in more than one NDL. In one example, an NDC may include STAs A, B, C, D, E, F, G, H, I. STA A may have a one-to-one link with STA B. STA B may have a one-to-many link with STAs C and D. STA A may also have a one-to-one link with STA E. STA D may have a one-to-one link with STA F. STA C may have a one-to-many link with STAs G, H, I. Although the foregoing example is a tree topology, the NDC may have any other topology. In another example, STA A may have a one-to-one link with STA H, and STA D may have a one-to-one link with STA I. STA C may have a one-to-many link with STAs B, G, and I. STAs A, B, D, E may have a many-to-many link with one another such that STA A is linked with STAs B, E, D, STA E is linked with B, D, and STA B is linked with D.

Wireless devices in a NAN data cluster may belong to more than one data link. In an aspect, wireless devices may negotiate a control channel schedule (or an NDC base schedule) such that all of the wireless devices within the NDC wakeup during a common time to exchange control information, which may include timing information, synchronization information, and/or other information associated with the NDC. In other words, the STAs A, B, C, D, E, F, G, H, I, which may be on the same or different NDL, may use a control channel schedule to determine when to be awake for receiving and/or exchanging control information. The control channel may be used to maintain synchronization in the event of a loss of synchronization or when a NAN cluster is merging.

For example, if option 1 is used, then the control channel schedule may be determined by the originator of the NDC (e.g., the STA 202). When the STA 202 creates the NDC as an originator, the STA 202 determines the control channel schedule based on, for example, the type of services associated with the NDC, a number of wireless devices, preconfigured information, and other information. After the control channel schedule is determined, the control channel schedule may no longer be modified.

In another example, if option 2 is used for control channel schedule negotiation, then only the originator of the NDC may modify the control channel schedule. For example, the STA 202 may determine the control channel schedule based on an availability of the STA 202, the requirements of a service provided within the NDC (e.g., quality of service requirements associated with the service), and/or preconfigured information. The STA 202 may transmit the schedule to other STAs in the NDC with a first timestamp. However, if the STA 202 determines that the control channel schedule requires updating, for the reasons discussed with respect to option 2 above, then the STA 202 may determine a new control channel schedule and transmit the schedule with a second timestamp.

In another example, if option 3 is used for control channel schedule negotiation, then the STA 202 may modify the schedule on its own or based on a request from another STA (e.g., the STA 204) that did not create the NDC.

In another example, if option 4 is used, then any STA within the NDC may modify the control channel schedule. If option 5 is used, then any STA within the NDC may propose a schedule modification for the control channel schedule. The STAs may transmit the proposed schedule modifications with an indicator associated with a scheduling priority of the STA. The schedule modification of the STA with the highest scheduling priority may be adopted by other STAs in the NDC.

In another example, if option 6 is used, then the originator that created the NDC (e.g., the STA 202) may periodically transmit messages to indicate the presence of the originator. If the originator lapses and does not transmit one or more of the periodic messages, then other STAs within the NDC may determine that the originator is no longer active, and may attempt to assume the scheduler role for the control channel schedule. The STAs may transmit an indicator with a proposed schedule, and the STA having the indicator with the highest priority, for example, may have its control channel schedule adopted and assume the scheduler role for the NDC.

In another example, if option 7 is used, then any STAs may sample a control channel schedule to determine the quality of the schedule during a schedule epoch. After sampling, any STA may transmit a proposed modification to the control channel schedule. STAs within the NDC may converge on a proposed control channel schedule associated based on the respective availability of the STAs to the proposed schedule modification and based on an indicator associated with a scheduling priority. Subsequently, a new control channel schedule may be adopted at the beginning of a subsequent schedule epoch.

In another example, if option 8 is used, then STAs may gradually adapt to a dynamically changing control channel schedule based on a preferred control channel schedule (e.g., S_self(C)) and a union of all of the received control channel schedules from other STAs in the NDC (e.g., S_union(C)). Together, the preferred control channel schedule and the union of the received control channel schedules may form a control channel schedule during which the STAs will be awake (e.g., S_all(C)). The control channel schedule may change continuously, however, as STAs transmit new preferred control channel schedules which may be different from their existing control channels schedules. As such, as with the many-to-many multicast schedule, the control channel schedule may have time blocks that are dynamically added and removed.

In another example, if option 9 is used, then any STA associated with the NDC may request to modify the control channel schedule by repeatedly transmitting the request in one or more time slots according to a countdown value. STAs with equal or higher priority may reject the modification request. If a rejection is received, then the STA no longer transmits the modification request. But if no rejection is received after the modification request has been transmitted a number of times equal to the countdown value, then the STA may transmit a change schedule request to request STAs within the NDC to change to a new control channel schedule. Other STAs in the NDC may repeat the modification request and/or the change schedule request.

In an aspect, a subset of the channel (or common) resource blocks (CRBs) allocated for the multicast schedule may be designated for the NDC control channel. During the subset of CRBs, synchronization beacons may be sent by a subset of the devices (based on master rank) to preserve synchronization. Messaging for signaling an NDC control channel change may also be sent during the NDC CRBs. In an aspect, a NDC attribute may be included along with the multicast schedule in the enrollment response message. NDC CRBs may be designated for both one-to-many and many-to-many multicast schedules. NDC CRBs may be associated with a synchronized NDL (S-NDL) as opposed to a paged-NDL (P-NDL). For S-NDL, STAs may be awake during full duration of all of the time blocks associated with the NDL. By contrast, for P-NDL, STAs may be awake during a paging window of the time block, but if no page is received, then the STAs may sleep for the remainder of the time block.

### Option 10—Schedule Change Using a Schedule Owner

An originator device (e.g., the STA 202) for NAN may create and/or modify a multicast schedule and provide the multicast schedule to other devices (e.g., enrollee devices, STAs 204, 206, 208, 210). In one-to-many multicast, an originator device of a group is a source of multicast data, and thus a multicast schedule may be changed by the originator device. In many-to-many multicast, there may be more than one source of multicast data in a group (e.g., NAN multicast service group (NMSG)). In many-to-many multicast, even when the originator device departs from the group, the group should be able to function and manage a multicast schedule. Therefore, an effective algorithm for multicast schedule management is desired for many-to-many multicast.

According to an aspect of the disclosure, in each multicast group (e.g., an NMSG) for many-to-many multicast, at least one device functions as a schedule owner. The schedule owner is capable of changing a multicast schedule for the group. In an aspect, in each group, only the schedule owner may change the multicast schedule (e.g., via a change schedule message). If an originator device (e.g., the STA 202) is present in the group, the originator device becomes the schedule owner.

When the schedule owner changes the multicast schedule for the group, the schedule owner may send a change schedule message to the group indicating that the multicast schedule has changed. The change schedule message may include a new (changed) multicast schedule and may further include a change time at which the devices in the group should start using the new multicast schedule. When the schedule owner transmits a change schedule message to the group, every device in the group that receives the change schedule message changes the multicast schedule to the new multicast schedule after receiving the change schedule message. The devices in the group may change the multicast schedule to the new multicast schedule at the change time indicated in the change schedule message. If no change time is indicated in the change schedule message, the devices in the group may change the new multicast schedule upon receiving the change schedule message. The devices in the group may rebroadcast the schedule change message received from the schedule owner.

The multicast schedule change may be initiated by a device in a group other than a schedule owner. In an aspect, a device that is not a schedule owner may request changing a multicast schedule by transmitting a change schedule request to the schedule owner to request the schedule owner to change the multicast schedule. The change schedule request may include a new multicast schedule, to request the schedule owner to change to the new multicast schedule. In response, the schedule owner may accept or reject the change schedule request. If the schedule owner accepts the change schedule request, the schedule owner changes the multicast schedule to a new multicast schedule, and transmits a schedule change message to devices in the group, such that the devices in the group may change the multicast schedule to the new multicast schedule based on the schedule change message. The schedule owner may also send an acceptance message to the requesting device to let the requesting device know that the change schedule request has been accepted. If the schedule owner rejects the change schedule request, the schedule owner sends a rejection message to the requesting device that sent the change schedule request. After receiving the rejection message, the requesting device that previously sent the change schedule request does not send another change schedule request for a fixed duration of time (e.g., 500 ms). The fixed duration of time may be a fixed value set within a device or may be signaled to the device from a server or a base station.

A device performing as the schedule owner may depart the group or may become inactive. In such a scenario, another device in the group may become a schedule owner. A device may determine that a schedule owner has departed the group if the device sends a change request message to the schedule owner and does not receive a response (e.g., schedule change message, acceptance message, or rejection message). In particular, a device may continue to send a change request message even when there is no response from the schedule owner. After sending a certain number of messages (e.g., N messages), if the device does not receive a response from the schedule owner, the device determines that a schedule owner does not exist in the group. When the device determines that a schedule owner does not exist, the device may send an owner announcement to other devices in the group, indicating that the device is a new schedule owner. For example, the owner announcement may be sent via broadcast, and may be sent in multiple messages. After sending the owner announcement to the group, the device becomes a schedule owner. Thus, as a schedule owner, the device may change the multicast schedule to the new multicast schedule and send a schedule change message to other devices in the group, to change the multicast schedule to the new multicast schedule.

Multiple devices in a group may simultaneously send change schedule requests to the a schedule owner. In such a scenario, the multiple devices may simultaneously determine that a schedule owner does not exist if no response to the change schedule request is received, and thus each of the multiple devices may simultaneously send owner announcements to the group to attempt to become a schedule owner in the group. Therefore, arbitrating among multiple devices simultaneously attempting to become a schedule owner is desired. The multiple devices simultaneously attempting to become a schedule owner may be ranked by one or more criteria. The rank information may be included in the owner announcements sent by the multiple devices. When other devices in the group receive the owner announcements from the multiple devices, the other devices may determine an owner announcement associated with a device with the highest rank, and determines that the device with the highest rank is the new schedule owner. Thus, when a device with a lower rank receives an owner announcement from a device with the highest rank, the device with the lower rank stops sending the owner announcement, and thus stops attempting to become a schedule owner. The rank may be based on at least one of a quality of service (QoS) condition, a latency condition, or a suitability of a new multicast schedule. In an aspect, the rank may be determined based on one of the methods described herein (e.g., the rank may be an indicator value as described previously). The suitability of a new multicast schedule may be based on historical data indicating whether a particular channel or a schedule was suitable in the past.

In an aspect, a periodic messaging feature similar to option 6 discussed above may be used to indicate the presence of the schedule owner. A schedule owner may periodically transmit periodic messages to indicate the presence of the schedule owner. The periodic message may be transmitted with a predefined periodicity. The periodic messages may function as a heartbeat indicating the presence of a device performing as a schedule owner. Thus, if a device in a group periodically receives the periodic messages from the schedule owner, the device may determine that the schedule owner is present in the group. On the other hand, if a device in the group determines that a periodic message was not received, the device may determine that the schedule owner no longer exists in the group. If the device determines that the schedule owner no longer exists in the group, the device may send an owner announcement to the group to attempt to become a schedule owner for the group. In one example, the device may determine that the schedule owner does not exist in the group if a certain number of periodic messages (e.g., M messages) are missed.

A device in a group may request a change in the multicast schedule by sending a change schedule request to a schedule owner of the group. In response to the change schedule request, the schedule owner may change the multicast schedule to a new multicast schedule, and may send a schedule change message to devices in the group during a next transmission of the periodic message. The schedule owner may also send an acceptance message to the requesting device to let the requesting device know that the change schedule request has been accepted. During the next transmission of the periodic message, the periodic message may include the schedule change message. The change schedule message may include a new (changed) multicast schedule and may further include a change time at which the devices in the group should start using the new multicast schedule. If the schedule owner determines not to change the multicast schedule in response to the change schedule request, the schedule owner may send a rejection message to the requesting device during the next transmission of the periodic message. If the schedule owner receives multiple change schedule requests from multiple devices, the schedule owner may select one of the multiple change schedule requests to select a new multicast schedule that is most suitable for the group. In particular, if multiple change schedule requests from multiple devices are received between transmissions of the periodic messages, the schedule owner may buffer the change schedule requests until a next transmission of the periodic message, and select one of the multiple change schedule requests to select a new multicast schedule. After the selection, the schedule owner may change the multicast schedule to a new multicast schedule of the selected change schedule request, and may send a schedule change message to devices in the group during a next transmission of the periodic message. The schedule owner may also send an acceptance message to the requesting device to let the requesting device know that the change schedule request has been accepted. If the schedule owner determines not to change the multicast schedule (thus rejecting all of the multiple change schedule requests), the schedule owner may send a rejection message to the requesting device during the next transmission of the periodic message.

In an aspect, to acknowledge that the schedule owner received the change schedule request, the schedule owner may send a receipt acknowledgement to the requesting device upon receiving the change schedule request. The receipt acknowledgement allows the requesting device determine that the schedule owner has received the change schedule request. The receipt acknowledgement provides acknowledgement of the change schedule request to the requesting device without waiting until the next transmission of the periodic message to provide an acceptance message or a rejection message. The requesting device may monitor for a receipt acknowledgment to determine whether the schedule owner is present in the group. In particular, if the requesting device does not receive a receipt acknowledgment after sending a change schedule request to a schedule owner, the requesting device may determine that the schedule owner does not exist in the group, and may attempt to become a schedule owner (e.g., by sending an owner announcement to the group).

If multiple devices simultaneously determines that a schedule owner does not exist in a group (e.g., in the absence of a receipt acknowledgement or a response to schedule change requests), each of the multiple devices may simultaneously send owner announcements to the group to attempt to become a schedule owner in the group. Therefore, as discussed above, arbitrating among multiple devices simultaneously attempting to become a schedule owner is desired. As discussed above, the multiple devices simultaneously attempting to become a schedule owner may be ranked by one or more criteria. When other devices in the group receive the owner announcements from the multiple devices, the other devices may determine an owner announcement associated with a device with the highest rank, and determines that the device with the highest rank is the new schedule owner. Thus, when a device with a lower rank receives an owner announcement from a device with the highest rank, the device with the lower rank stops sending the owner announcement, and thus stops attempting to become a schedule owner.

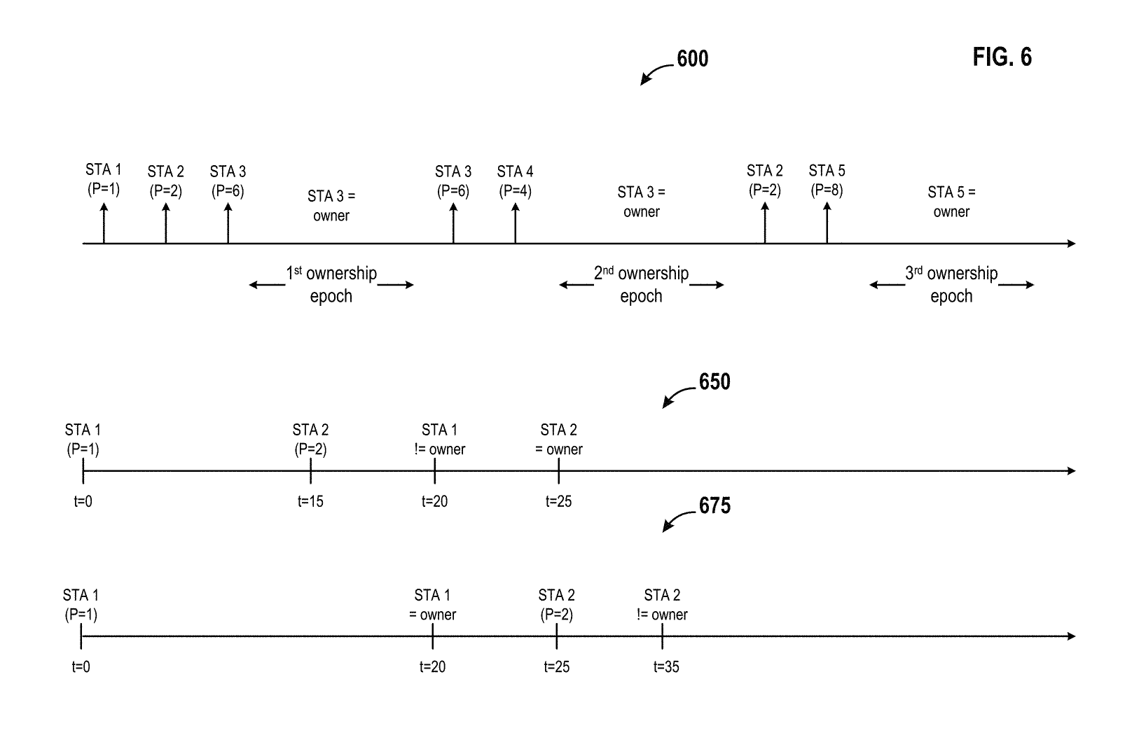

FIG. 6 are diagrams 600, 650, 675 of methods for using a hysteresis-type mechanism to prevent frequency ownership change. As previously discussed, a multicast schedule of a multicast group may be managed by a schedule owner. The schedule owner may be a STA that originates the multicast group, or if the originating device becomes unavailable, another STA that is a member of the multicast group may assume ownership of the multicast schedule. If multiple STAs want to contend for ownership, the STA with the highest priority may become the schedule owner. Because the number of STAs in a multicast group may change continuously (e.g., STAs may enter or leave the group), frequent ownership change is possible. Frequent ownership change may create inefficiencies, device confusion, and overhead, and therefore, a need exists to prevent frequent ownership change. As discussed below, frequent ownership change may be reduced by using a hysteresis mechanism.

In one configuration, an ownership epoch may be used. That is, the multicast group may be associated with one or more ownership epochs (e.g., a repeating time slot or duration) during which ownership change is allowed. In this configuration, STAs may request ownership change at any time before a respective ownership epoch, but the change may occur only during the ownership epoch. If multiple STAs request to be the owner, then the STA with the highest priority may become the owner during the ownership epoch.

For example, referring to the diagram 600, the owner of a multicast group may no longer be available (e.g., STA 0). STAs 1, 2, 3 may determine that STA 0 is no longer available because signals have not been received from STA 0 for a predetermined period of time. For example, STA 1, 2, 3, may have transmitted a request to change the schedule and may not have received a response from STA 0. If either a positive or negative response from STA 0 was received, then no change for schedule ownership may be sent because STA 0 is still active. However, because STA 0 is determined to be inactive, then STAs 1, 2, 3 to compete for ownership of the schedule. STA 1 with a priority of 1, STA 2 with a priority of 2, and STA 3 with a priority of 6 may each request to become the owner. Because STA 3 has the highest priority, STA 3 may become the owner during a first ownership epoch. Subsequently, STAs 3, 4 may request to be the owner. Because STA 4 has a priority of 4, which is lower than the priority of STA 3, STA 3 may remain the owner and no ownership change may occur in a second ownership epoch. Subsequently, STA 3 may become unavailable and STAs 2, 5 may request to become the owner. STA 5 may have a priority of 8, which is greater than the priority of STA 2. Accordingly, at the third ownership epoch, STA 5 may become the owner. In this example, ownership may only change during the ownership epochs. Ownership may not change outside of the ownership epochs. In this configuration, the hysteresis value may be the time period in between ownership epochs. The advantage of an ownership epoch is that the ownership epoch is unambiguous. All participants or STAs know exactly when owner change is allowed and how long to wait before a next ownership change is permitted. That is, the epoch does not depend on when a recent update occurred. In an aspect, the ownership epoch may occur at regular intervals and an update may or may not occur. In another aspect, the ownership epochs may be aperiodic and not a fixed value. That is, a schedule owner may dynamically indicate the hysteresis value for which ownership may not change. For example, the current schedule owner may indicate that a new owner is not allowed for the next 5 seconds or the next 20 seconds. In another example, the new schedule owner may indicate that a new owner is not allowed for the next 20 seconds, and the ownership epoch has a 15 second duration. In another aspect, different multicast groups may have different ownership change properties. For example, a STA may be associated with a first multicast group with periodic ownership epochs and be associated with a second multicast group with aperiodic ownership epochs (or ownership epochs with a different periodicity).

In another aspect, epoch information such as an ownership epoch duration, when the ownership epoch begins, a length of time for which ownership is required to remain static, and/or the ownership epoch periodicity (if applicable) may be a property of the NDL (negotiated during schedule setup), a standard defined or well-known property, or a property of the NAN cluster. In an aspect, epoch information may be transmitted during ownership announcement when a new owner assumes control of the schedule or as part of a schedule announcement when a new schedule is negotiated or when a new schedule is determined.

Diagrams 650 and 675 together illustrate another method of using a hysteresis mechanism to prevent frequent ownership changes. In diagram 650, STA 1 with a priority 1 may determine that the owner is unavailable and request to assume ownership of the multicast group at time t=0. STA 1 may indicate that STA 1 intends to assume ownership at time t=20. Subsequently, at time t=15, before STA 1 has assumed ownership, STA 2 may request to assume ownership. STA 2, with a priority of 2, has a higher priority than STA 1 and invalidates the request of STA 1. As such, STA 1 does not become the owner at t=20. Instead, STA 2 becomes the owner at t=25. In this example, a hysteresis value is not used, but this example illustrates how a STA with a higher priority may invalidate another STA's request for ownership.

In diagram 675, STA 1 requests to assume ownership at t=0 and indicates that STA 1 will become the owner at t=20. After STA 1 becomes the owner at t=20, STA 2, with a higher priority, transmits a request to become an owner at t=25. STA 2 may indicate that STA 2 may assume ownership at t=35. In this case, assuming a hysteresis value with a time value of 20, then ownership may not change within 20 time units of a prior ownership change. Therefore, after STA 1 becomes the owner at t=20, ownership of the multicast schedule may not change to another STA until t=40 or later. Accordingly, the request by STA 2 to assume ownership will be denied, even though STA 2 has a higher priority than STA 1. By contrast, had the hysteresis value been 15 or less, then the ownership would have changed to STA 2.

In the aforementioned examples, the hysteresis value may be fixed or dynamically determined as part of a schedule negotiation. The hysteresis value may be transmitted in a number of messages, including a schedule announcement and/or an ownership announcement.

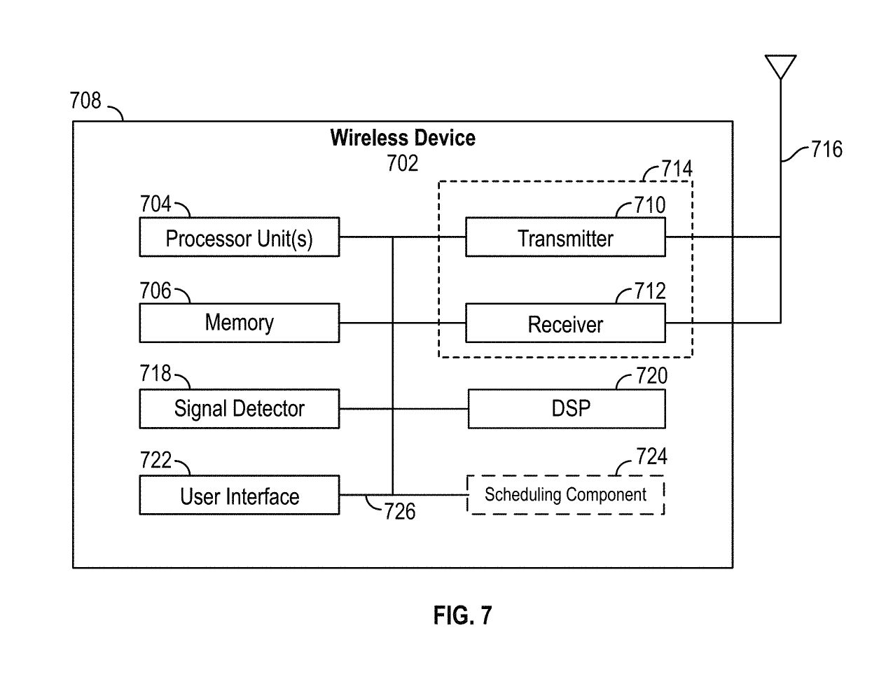

FIG. 7 shows an example functional block diagram of a wireless device 702 that may perform schedule negotiations within the wireless communication system 100 of FIG. 1. The wireless device 702 is an example of a device that may be configured to implement the various methods described herein. For example, the wireless device 702 may comprise one of the STAs 114, 202, 204, 206, 208, 210.

The wireless device 702 may include a processor 704, which controls operation of the wireless device 702. The processor 704 may also be referred to as a central processing unit (CPU). Memory 706, which may include both read-only memory (ROM) and random access memory (RAM), may provide instructions and data to the processor 704. A portion of the memory 706 may also include non-volatile random access memory (NVRAM). The processor 704 typically performs logical and arithmetic operations based on program instructions stored within the memory 706. The instructions in the memory 706 may be executable (by the processor 704, for example) to implement the methods described herein.

The processor 704 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 702 may also include a housing 708, and the wireless device 702 that may include a transmitter 710 and/or a receiver 712 to allow transmission and reception of data between the wireless device 702 and a remote device. The transmitter 710 and the receiver 712 may be combined into a transceiver 714. An antenna 716 may be attached to the housing 708 and electrically coupled to the transceiver 714. The wireless device 702 may also include multiple transmitters, multiple receivers, multiple transceivers, and/or multiple antennas.

The wireless device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The wireless device 702 may also include a DSP 720 for use in processing signals. The DSP 720 may be configured to generate a packet for transmission. In some aspects, the packet may comprise a physical layer convergence procedure (PLCP) protocol data unit (PPDU).

The wireless device 702 may further comprise a user interface 722 in some aspects. The user interface 722 may comprise a keypad, a microphone, a speaker, and/or a display. The user interface 722 may include any element or component that conveys information to a user of the wireless device 702 and/or receives input from the user.

When the wireless device 702 is implemented as a STA (e.g., the STA 114), the wireless device 702 may also comprise a scheduling component 724. In one configuration, when the wireless device 702 is operating as a schedule owner, the scheduling component 724 may be configured to determine a many-to-many multicast schedule for an NDL of a service associated with a NAN network. The scheduling component 724 may be configured to communicate with wireless devices subscribed to the service based on the determined many-to-many multicast schedule. In this configuration, the wireless device 702 may be a schedule owner of the many-to-many multicast schedule. In an aspect, the many-to-many multicast schedule for the NDL may include repeating TBs between DWs, and a first subset of the repeating TBs is on a same channel or a different channel than a second subset of the repeating TBs. In an aspect, the scheduling component 724 may be further configured to transmit the determined many-to-many multicast schedule. In this aspect, the scheduling component 724 may be configured to determine the many-to-many multicast schedule by determining a time at which the many-to-many multicast schedule will become active. In this aspect, the transmission may also include the time at which the many-to-many multicast schedule will become active. In an aspect, the scheduling component 724 may be further configured to determine whether to change the many-to-many multicast schedule to a second many-to-many multicast schedule and to transmit the second many-to-many multicast schedule and a time at which the second many-to-many multicast schedule will become active. In another aspect, the scheduling component 724 may be further configured to receive, from a second device, a change schedule request to change the many-to-many multicast schedule. In an aspect, the determination to change the many-to-many multicast schedule may be based on the received change schedule request. In another aspect, the scheduling component 724 may be further configured to transmit, to the second device, an acceptance message in response to the change schedule request if the scheduling component 724 determines to change the many-to-many multicast schedule or to transmit, to the second device, a rejection message in response to the change schedule request if the scheduling component 724 determines not to change the many-to-many multicast schedule. In another aspect, the determination to change the many-to-many multicast schedule may be based on at least one of a QoS condition, a latency condition, or suitability of the second many-to-many multicast schedule.

In another configuration, when the wireless device 702 is operating as a subscribing device, the scheduling component 724 may be configured to receive a many-to-many multicast schedule for an of a service associated with a NAN network and to communicate over the NDL based on the received many-to-many multicast schedule. In an aspect, the scheduling component 724 may be further configured to transmit a change schedule request to a schedule owner device to request a change of the many-to-many multicast schedule. In another aspect, the scheduling component 724 may be further configured to receive a second many-to-many multicast schedule from the schedule owner device to change the many-to-many multicast schedule to the second many-to-many multicast schedule after the wireless device receives an acceptance message in response to the change schedule request or to refrain from changing the many-to-many multicast schedule when the wireless device receives a rejection message in response to the change schedule request. In another aspect, the scheduling component 724 may be further configured to refrain from transmitting another change schedule request to the schedule owner device for a backoff time duration after receiving the rejection message. In another aspect, the scheduling component 724 may be further configured to repeat the transmission of the change schedule request to the schedule owner device when the scheduling component 724 does not receive a response from the schedule owner device in response to the change schedule request and to transmit a schedule owner update message to become a schedule owner when a number of transmissions of the change schedule request to the schedule owner device exceeds an attempt threshold without a response from the schedule owner device. In this aspect, the schedule owner update message may include a schedule owner transition time. In another aspect, the scheduling component 724 may be further configured to determine to become the schedule owner of the many-to-many multicast schedule when the wireless device does not receive another schedule owner update message from another wireless device having a higher rank than a rank of the wireless device after the expiration of the schedule owner transition time and to announce to one or more devices that the wireless device 702 is the schedule owner device based on the determination to become the schedule owner. In another aspect, the scheduling component 724 may be further configured to receive at least one other schedule owner change request from at least one other device requesting to become the schedule owner before the schedule owner transition time expires and to determine whether to become the schedule owner based on whether a rank of the at least one device is higher than a rank of the wireless device. In another aspect, the scheduling component 724 may be further configured to determine to stop transmitting the schedule owner update message when the rank of the at least one device is higher than the rank of the wireless device. In another aspect, the scheduling component 724 may be further configured to monitor for a message received periodically from a schedule owner device. The message may enable a determination of a presence of the schedule owner device. In another aspect, the scheduling component 724 may be further configured to receive a schedule owner update message that indicates a different schedule owner for the many-to-many multicast schedule and to update the schedule owner device to correspond to the different schedule owner.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the scheduling component 724. Further, each of the components illustrated in FIG. 7 may be implemented using a plurality of separate elements.

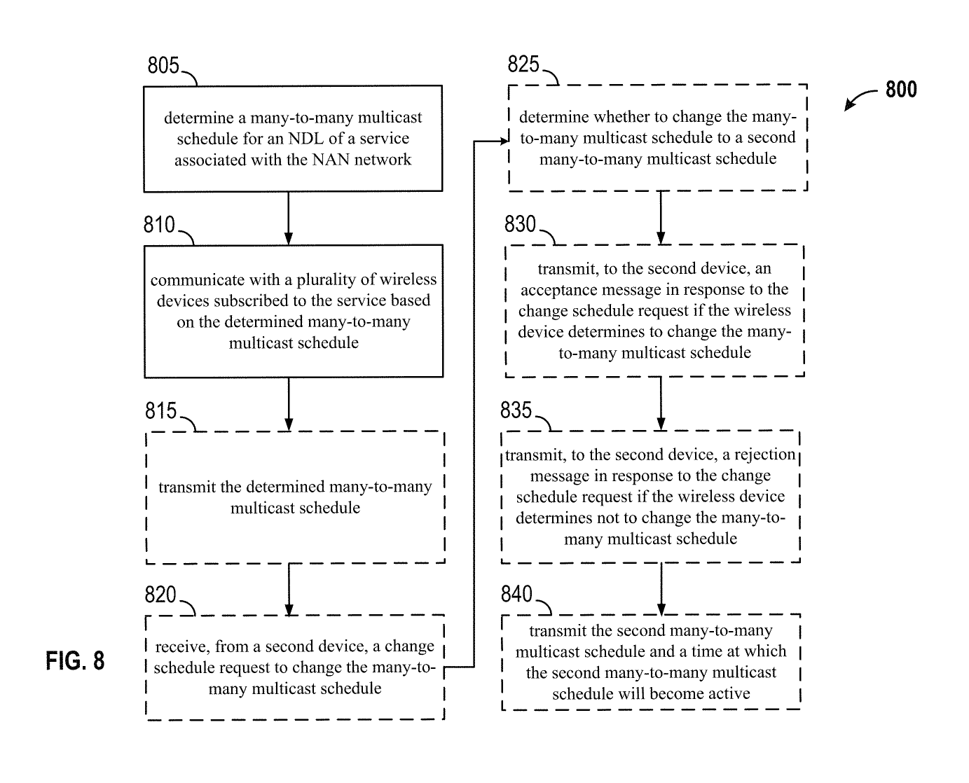

FIG. 8 is a flowchart of a method 800 for performing many-to-many multicast scheduling by a schedule owner. The method 800 may be performed using an apparatus (e.g., the STA 114, the STAs 202, 204, 206, 208, 210, for example). Although the method 800 is described below with respect to the elements of wireless device 702 of FIG. 7, other components may be used to implement one or more of the steps described herein.

At 805, the apparatus may determine a many-to-many multicast schedule for an NDL of a service associated with the NAN network. For example, referring to FIG. 2, the apparatus may be the STA 202. The STA 202 may determine the many-to-many multicast schedule based on QoS requirements of the service (e.g., determine whether service requires high throughput and/or low latency), channel latency, wireless traffic, and/or other factors.

At 810, the apparatus may communicate with a plurality of wireless devices subscribed to the serviced based on the determined many-to-many multicast schedule. For example, referring to FIG. 2, the STA 202 may communicate with STAs 204, 208 based on the determined many-to-many multicast schedule.

At 815, the apparatus may transmit the determined many-to-many multicast schedule. For example, referring to FIG. 2, the STA 202 may transmit the determined many-to-many multicast schedule to the STAs 204, 208.

At 820, the apparatus may receive, from a second device, a change schedule request to change the many-to-many multicast schedule. In an aspect, the change schedule request may include a proposed schedule from the second device. For example, referring to FIG. 2, the STA 202 may receive, from the STA 204, a change schedule request to change the many-to-many multicast schedule.

At 825, the apparatus may determine whether to change the many-to-many multicast schedule to a second many-to-many multicast schedule. For example, referring to FIG. 2, the STA 202 may determine whether to change the many-to-many multicast schedule to a second many-to-many multicast schedule. In one aspect, the STA 202 may determine to change the many-to-many multicast schedule without having received a request to change the schedule. In this aspect, the STA 202 may determine that the existing schedule is associated with high packet error or low signal strength and determine to change to a different schedule. In another aspect, the STA 202 may determine to change the many-to-many multicast schedule based on the received change schedule request. In an aspect, the request may include the second many-to-many schedule.

In one configuration, at 830, the apparatus may be configured to transmit, to the second device, an acceptance message in response to the change schedule request if the apparatus determines to change the many-to-many multicast schedule. For example, referring to FIG. 2, the STA 202 may be configured to transmit an acceptance message in response to the change schedule request from the STA 204 if the STA 202 determines to change the many-to-many multicast schedule.

In another configuration, at 835, the apparatus may be configured to transmit, to the STA 204, a rejection message in response to the change schedule request if the STA 202 determines not to change the many-to-many multicast schedule.

At 840, when the apparatus determines to change the many-to-many multicast schedule to the second many-to-many multicast schedule, the apparatus may transmit the second many-to-many multicast schedule. The transmission may include a time at which the second many-to-many multicast schedule will become active or take effect. For example, referring to FIG. 2, the STA 202 may determine to transmit the second many-to-many multicast schedule and indicate a time at which the second many-to-many multicast schedule will become effective.

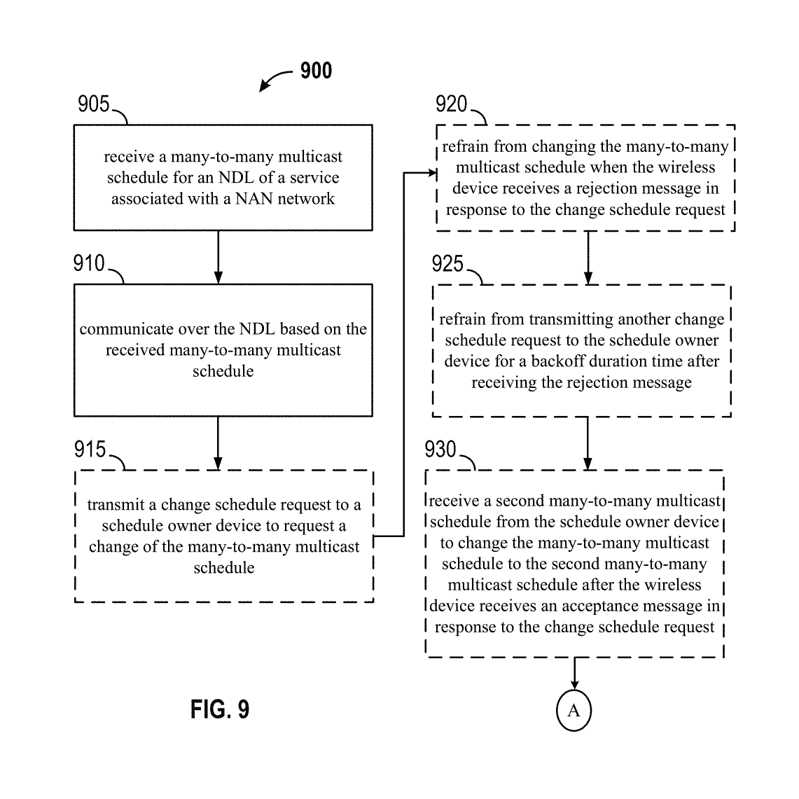

FIGS. 9-11 are flowcharts of methods 900, 1000, 1100 for performing many-to-many multicast scheduling. The methods 900, 1000, 1100 may be performed using an apparatus (e.g., the STA 114, the STAs 202, 204, 206, 208, 210, for example). Although the methods 900, 1000, 1100 are described below with respect to the elements of wireless device 702 of FIG. 7, other components may be used to implement one or more of the steps described herein.

At 905, the apparatus may receive a many-to-many multicast schedule for an NDL of a service associated with a NAN network. For example, referring to FIG. 2, the apparatus may be the STA 204. The STA 204 may receive, from the STA 202 (the schedule owner device), a many-to-many multicast schedule for the NDL of a service associated with the NAN network.

At 910, the apparatus may communicate over the NDL based on the received many-to-many multicast schedule. For example, referring to FIG. 2, the STA 204 may communicate over the NDL with the STAs 202, 208, and/or other STAs based on the received many-to-many multicast schedule.

At 915, the apparatus may transmit a change schedule request to a schedule owner device to request a change of the many-to-many multicast schedule. For example, referring to FIG. 2, the STA 202 may transmit a change schedule request to the STA 202 to request a change of the many-to-many multicast schedule. The change schedule request may include a second many-to-many multicast schedule proposed for adoption by the STA 204.

At 920, the apparatus may refrain from changing the many-to-many multicast schedule stored at the apparatus when the apparatus receives a rejection message in response to the change schedule request. For example, the STA 204 may refrain from modifying the stored many-to-many multicast schedule if the STA 204 receives a rejection message from the STA 202 indicating that the request has been rejected.

At 925, the apparatus may refrain from transmitting another change schedule request to the schedule owner device for a backoff time duration after receiving the rejection message. For example, the STA 204 may determine that the STA 204 would like to request another schedule change but may determine not to transmit another change schedule request until after a backoff time duration after the STA 204 receive the rejection message from the STA 202 indicating that the STA 202 will not change the many-to-many multicast schedule.

At 930, the apparatus may receive a second many-to-many multicast schedule from the schedule owner device to change the many-to-many multicast schedule to the second many-to-many multicast schedule after the apparatus receive an acceptance message in response to the change schedule request. For example, referring to FIG. 2, the STA 202 may determine to adopt the many-to-many multicast schedule proposed by the STA 204 or a similar schedule based on the proposed schedule. The STA 204 may receive the second many-to-many multicast schedule (the new schedule) from the STA 202 after receiving an acceptance message in response to the change schedule request. Although the STA 202 may also determine to change the many-to-many multicast schedule without having received any request to change it. The second many-to-many multicast schedule may be transmitted with a time indicating when the second many-to-many multicast schedule will come into effect.

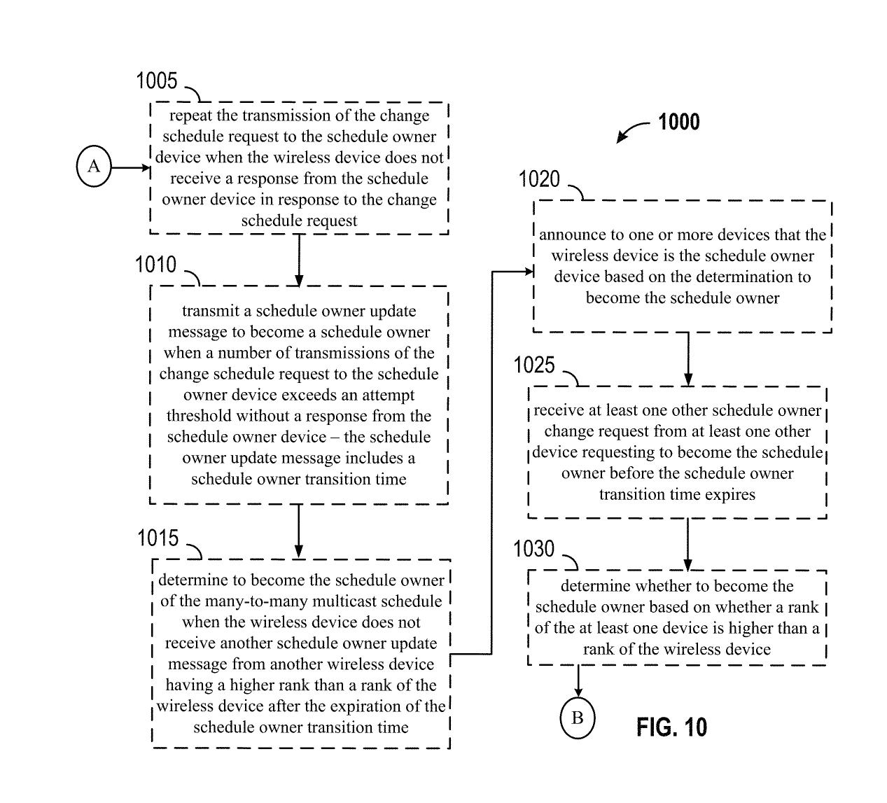

Continuing to FIG. 10, at 1005, the apparatus may repeat the transmission of the change schedule request to the schedule owner device when the apparatus does not receive a response from the schedule owner device in response to the change schedule request. For example, referring to FIG. 2, the STA 204 may retransmit the change schedule request if the STA 204 does not receive either an acceptance message or a rejection message in response to the change schedule request after a period of time. In an aspect, the STA 204 may retransmit the change schedule request seven (or any other number of times) before determining that the schedule owner device is inactive.

At 1010, when the apparatus determines that the schedule owner device is inactive, the apparatus may transmit a schedule owner update message to become a schedule owner when a number of transmissions (or retransmissions) of the change schedule request to the schedule owner device exceeds an attempt threshold without a response from the schedule owner device. The schedule owner update message may include a schedule owner transition time that indicates when the apparatus will assume the schedule owner role unless another device contends to be the schedule owner. For example, referring to FIG. 2, the STA 204 may transmit a schedule owner update message to become the schedule owner after transmitting the change schedule request 7 times. The schedule owner update message may indicate that the STA 204 will become the new scheduler owner unless someone else contends to be the schedule owner within a period of time (e.g., a TSF value).

In one configuration, at 1015, the apparatus may determine to become the schedule owner of the many-to-many multicast schedule when the apparatus does not receive another schedule owner update message from another wireless device having a higher rank than a rank of the apparatus after the expiration of the schedule owner transition time. For example, referring to FIG. 2, the STA 204 may determine to become the schedule owner of the many-to-many multicast schedule when the STA 204 does not receive a schedule owner update message from another wireless device having a higher rank than the rank of the STA 204. But if the STA 204 receives a schedule owner update message from another wireless device having a higher rank than the STA 204, then the STA 204 may determine not to assume the schedule owner role.

At 1020, the apparatus may announce to one or more devices that the apparatus is the schedule owner based on the determination to become the schedule owner. For example, referring to FIG. 2, the STA 204 may announce to STAs 206, 208, and other STAs that the STA 204 is the new schedule owner by transmitting the many-to-many multicast schedule in a frame (e.g., a NAN action frame).

In another configuration, at 1025, the apparatus may receive at least one other schedule owner change request from at least one other device requesting to become the schedule owner before the schedule owner transition time expires. For example, referring to FIG. 2, the STA 204 may receive a schedule owner change request from the STA 206 requesting to become the schedule owner before the schedule owner transition time expires.

At 1030, the apparatus may determine whether to become the schedule owner based on whether a rank of the at least one device is higher than a rank of the apparatus. For example, referring to FIG. 2, the STA 204 may determine whether to become the scheduler owner based on whether the rank of the STA 206 is higher than the rank of the STA 204. If the rank of the STA 204 is higher, than the STA 204 may determine to become the schedule owner. By contrast, if the rank of the STA 206 is higher, then the STA 204 may not assume the schedule owner role.

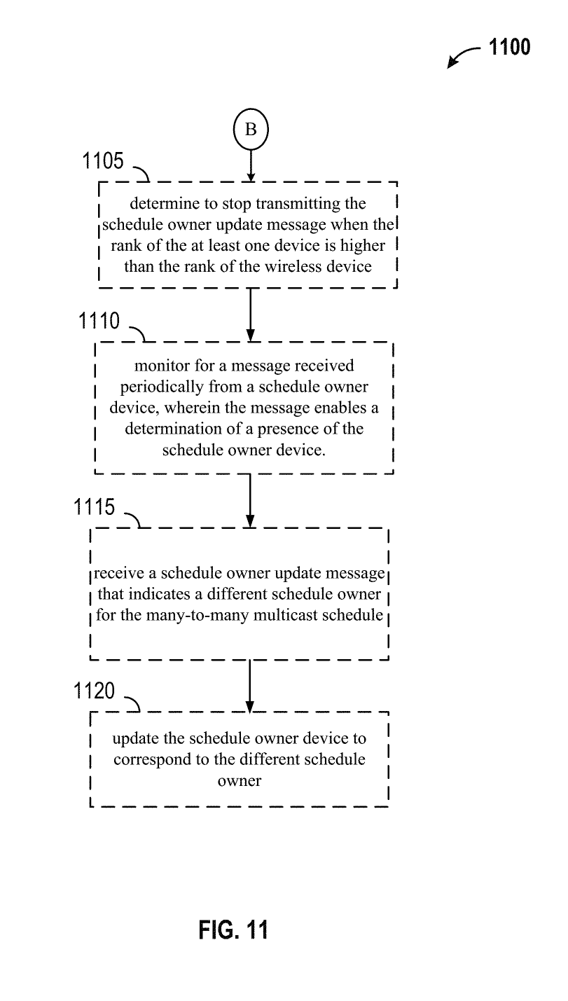

Continuing to FIG. 11, at 1105, the apparatus may determine to stop transmitting the schedule owner update message when the rank of the at least one device his higher than the rank of the apparatus. For example, referring to FIG. 2, the STA 204 may determine to stop transmitting the schedule owner update message if the rank of the STA 206 is higher than the rank of the STA 204.

At 1110, the apparatus may determine to monitor for a message received periodically from a schedule owner device. The message may enable the apparatus to determine a presence of the schedule owner device. For example, referring to FIG. 2, the STA 204 may monitor for a message received periodically from the STA 202. The message may include the many-to-many multicast schedule or other information. If the STA 204 receives the message periodically, then the STA 204 may assume that the STA 202 is still active. Otherwise, the STA 204 may attempt to become the schedule owner if the STA 202 is inactive.

At 1115, the apparatus may receive a schedule owner update message that indicates a different schedule owner for the many-to-many multicast schedule. For example, referring to FIG. 2, the STA 208 may become the schedule owner device, and the STA 204 may receive the schedule owner update message that indicates the STA 208 is the schedule owner for the many-to-many multicast schedule. In an aspect, the schedule owner update message may include a new schedule.

At 1120, the apparatus may update the schedule owner device to correspond to the different schedule owner. For example, referring to FIG. 2, the STA 204 may update the schedule owner device from the STA 202 to the STA 208. If the schedule owner update message may include a new many-to-many multicast schedule, and the STA 204 may adopt the new many-to-many multicast schedule.

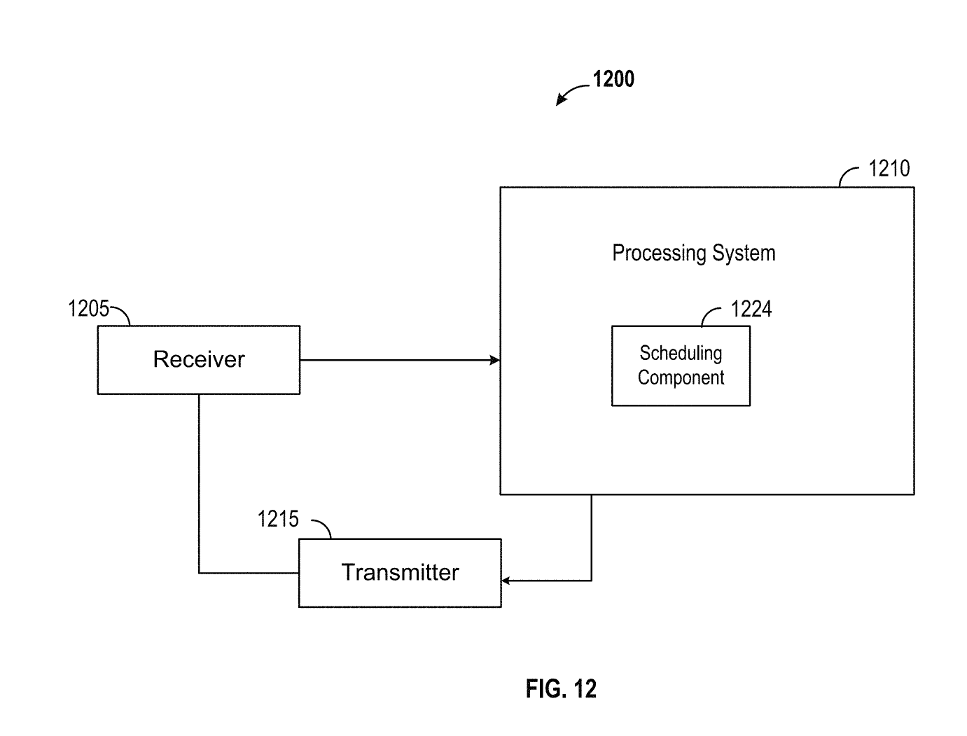

FIG. 12 is a functional block diagram of an example wireless communication device 1200 that performs scheduling. The wireless communication device 1200 may include a receiver 1205, a processing system 1210, and a transmitter 1215. The processing system 1210 may include a scheduling component 1224.

In one configuration, when the wireless communication device 1200 is operating as a schedule owner, the processing system 1210 and/or the scheduling component 1224 may be configured to determine a many-to-many multicast schedule for an NDL of a service associated with a NAN network. The transmitter 1215, the receiver 1205, the processing system 1210, and/or the scheduling component 1224 may be configured to communicate with wireless devices subscribed to the service based on the determined many-to-many multicast schedule. In this configuration, the wireless communication device 1200 may be a schedule owner of the many-to-many multicast schedule. In an aspect, the many-to-many multicast schedule for the NDL may include repeating TBs between DWs, and a first subset of the repeating TBs is on a same channel or a different channel than a second subset of the repeating TBs. In an aspect, the transmitter 1215, the processing system 1210, and/or the scheduling component 1224 may be further configured to transmit the determined many-to-many multicast schedule. In this aspect, the processing system 1210 and/or the scheduling component 1224 may be configured to determine the many-to-many multicast schedule by determining a time at which the many-to-many multicast schedule will become active. In this aspect, the transmission may also include the time at which the many-to-many multicast schedule will become active. In an aspect, the processing system 1210 and/or the scheduling component 1224 may be further configured to determine whether to change the many-to-many multicast schedule to a second many-to-many multicast schedule and to transmit the second many-to-many multicast schedule and a time at which the second many-to-many multicast schedule will become active. In another aspect, the receiver 1205, the processing system 1210, and/or the scheduling component 1224 may be further configured to receive, from a second device, a change schedule request to change the many-to-many multicast schedule. In an aspect, the determination to change the many-to-many multicast schedule may be based on the received change schedule request. In another aspect, the transmitter 1215, the processing system 1210, and/or the scheduling component 1224 may be further configured to transmit, to the second device, an acceptance message in response to the change schedule request if the wireless communication device 1200 determines to change the many-to-many multicast schedule or to transmit, to the second device, a rejection message in response to the change schedule request if the processing system 1210 and/or the scheduling component 1224 determines not to change the many-to-many multicast schedule. In another aspect, the determination to change the many-to-many multicast schedule may be based on at least one of a QoS condition, a latency condition, or suitability of the second many-to-many multicast schedule.

In one configuration, when the wireless communication device 1200 is operating as a schedule owner, the wireless communication device 1200 may include means for determining a many-to-many multicast schedule for an NDL of a service associated with a NAN network and means for communicating with wireless devices subscribed to the service based on the determined many-to-many multicast schedule. In this configuration, the wireless communication device 1200 may be a schedule owner of the many-to-many multicast schedule. In an aspect, the many-to-many multicast schedule for the NDL may include repeating TBs between DWs, and a first subset of the repeating TBs is on a same channel or a different channel than a second subset of the repeating TBs. In an aspect, the wireless communication device 1200 may include means for transmitting the determined many-to-many multicast schedule. In this aspect, the means for determining the many-to-many multicast schedule may be configured to determine a time at which the many-to-many multicast schedule will become active. In this aspect, the transmission may also include the time at which the many-to-many multicast schedule will become active. In an aspect, the wireless communication device 1200 may include means for determining whether to change the many-to-many multicast schedule to a second many-to-many multicast schedule and to transmit the second many-to-many multicast schedule and a time at which the second many-to-many multicast schedule will become active. In another aspect, the wireless communication device 1200 may include means for receiving, from a second device, a change schedule request to change the many-to-many multicast schedule. In an aspect, the determination to change the many-to-many multicast schedule may be based on the received change schedule request. In another aspect, the wireless communication device 1200 may include means for transmitting, to the second device, an acceptance message in response to the change schedule request if the wireless communication device 1200 determines to change the many-to-many multicast schedule and means for transmitting, to the second device, a rejection message in response to the change schedule request if the wireless communication device 1200 determines not to change the many-to-many multicast schedule. In another aspect, the determination to change the many-to-many multicast schedule may be based on at least one of a QoS condition, a latency condition, or suitability of the second many-to-many multicast schedule.

For example, the means for performing the aforementioned functions may include one or more of the transmitter 1215, the receiver 1205, the processing system 1210, and/or the scheduling component 1224.

In another configuration, when the wireless communication device 1200 is operating as a subscribing device, the receiver 1205, the processing system 1210, and/or the scheduling component 1224 may be configured to receive a many-to-many multicast schedule for an of a service associated with a NAN network and to communicate over the NDL based on the received many-to-many multicast schedule. In an aspect, the transmitter 1215, the processing system 1210, and/or the scheduling component 1224 may be further configured to transmit a change schedule request to a schedule owner device to request a change of the many-to-many multicast schedule. In another aspect, the receiver 1205, the processing system 1210, and/or the scheduling component 1224 may be further configured to receive a second many-to-many multicast schedule from the schedule owner device to change the many-to-many multicast schedule to the second many-to-many multicast schedule after the wireless device receives an acceptance message in response to the change schedule request or to refrain from changing the many-to-many multicast schedule when the wireless device receives a rejection message in response to the change schedule request. In another aspect, the processing system 1210, and/or the scheduling component 1224 may be further configured to refrain from transmitting another change schedule request to the schedule owner device for a backoff time duration after receiving the rejection message. In another aspect, the transmitter 1215, the processing system 1210, and/or the scheduling component 1224 may be further configured to repeat the transmission of the change schedule request to the schedule owner device when the wireless communication device 1200 does not receive a response from the schedule owner device in response to the change schedule request and to transmit a schedule owner update message to become a schedule owner when a number of transmissions of the change schedule request to the schedule owner device exceeds an attempt threshold without a response from the schedule owner device. In this aspect, the schedule owner update message may include a schedule owner transition time. In another aspect, the processing system 1210 and/or the scheduling component 1224 may be further configured to determine to become the schedule owner of the many-to-many multicast schedule when the wireless device does not receive another schedule owner update message from another wireless device having a higher rank than a rank of the wireless device after the expiration of the schedule owner transition time and to announce to one or more devices that the wireless communication device 1200 is the schedule owner device based on the determination to become the schedule owner. In another aspect, the receiver 1205, the processing system 1210, and/or the scheduling component 1224 may be further configured to receive the least one other schedule owner change request from at least one other device requesting to become the schedule owner before the schedule owner transition time expires and to determine whether to become the schedule owner based on whether a rank of the at least one device is higher than a rank of the wireless device. In another aspect, the processing system 1210 and/or the scheduling component 1224 may be further configured to determine to stop transmitting the schedule owner update message when the rank of the at least one device is higher than the rank of the wireless device. In another aspect, the receiver 1205, the processing system 1210, and/or the scheduling component 1224 may be further configured to monitor for a message received periodically from a schedule owner device. The message may enable a determination of a presence of the schedule owner device. In another aspect, the receiver 1205, the processing system 1210, and/or the scheduling component 1224 may be further configured to receive a schedule owner update message that indicates a different schedule owner for the many-to-many multicast schedule and to update the schedule owner device to correspond to the different schedule owner.

In another configuration, when the wireless communication device 1200 is operating as a subscribing device, the wireless communication device 1200 may include means for receiving a many-to-many multicast schedule for an of a service associated with a NAN network and for communicating over the NDL based on the received many-to-many multicast schedule. In an aspect, the wireless communication device 1200 may include means for transmitting a change schedule request to a schedule owner device to request a change of the many-to-many multicast schedule. In another aspect, the wireless communication device 1200 may include means for receiving a second many-to-many multicast schedule from the schedule owner device to change the many-to-many multicast schedule to the second many-to-many multicast schedule after the wireless device receives an acceptance message in response to the change schedule request or to refrain from changing the many-to-many multicast schedule when the wireless device receives a rejection message in response to the change schedule request. In another aspect, the wireless communication device 1200 may include means for refraining from transmitting another change schedule request to the schedule owner device for a backoff time duration after receiving the rejection message. In another aspect, the wireless communication device 1200 may include means for repeating the transmission of the change schedule request to the schedule owner device when the wireless communication device 1200 does not receive a response from the schedule owner device in response to the change schedule request and to transmit a schedule owner update message to become a schedule owner when a number of transmissions of the change schedule request to the schedule owner device exceeds an attempt threshold without a response from the schedule owner device. In this aspect, the schedule owner update message may include a schedule owner transition time. In another aspect, the wireless communication device 1200 may include means for determining to become the schedule owner of the many-to-many multicast schedule when the wireless device does not receive another schedule owner update message from another wireless device having a higher rank than a rank of the wireless device after the expiration of the schedule owner transition time and to announce to one or more devices that the wireless communication device 1 is the schedule owner device based on the determination to become the schedule owner. In another aspect, the wireless communication device 1200 may include means for receiving the least one other schedule owner change request from at least one other device requesting to become the schedule owner before the schedule owner transition time expires and to determine whether to become the schedule owner based on whether a rank of the at least one device is higher than a rank of the wireless device. In another aspect, the wireless communication device 1200 may include means for determining to stop transmitting the schedule owner update message when the rank of the at least one device is higher than the rank of the wireless device. In another aspect, the wireless communication device 1200 may include means for monitoring for a message received periodically from a schedule owner device. The message may enable a determination of a presence of the schedule owner device. In another aspect, the wireless communication device 1200 may include means for receiving a schedule owner update message that indicates a different schedule owner for the many-to-many multicast schedule and to update the schedule owner device to correspond to the different schedule owner.

For example, the means for performing the aforementioned functions may include one or more of the transmitter 1215, the receiver 1205, the processing system 1210, and/or the scheduling component 1224.

The receiver 1205 may correspond to the receiver 712. The processing system 1210 may correspond to the processor 704. The transmitter 1215 may correspond to the transmitter 710. The scheduling component 1224 may correspond to the scheduling component 124, and/or the scheduling component 724.

In an aspect, the NDL and NDP principles described herein, including the many-to-many multicast schedule negotiation techniques, may also be applicable to any other communication protocols, such as communication protocols that involve many-to-many multicast communications in an ad hoc network (e.g., networks without an access point or base station).

The various operations of methods described above may be performed by any suitable means capable of performing the operations, such as various hardware and/or software component(s), circuits, and/or component(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, a FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication, comprising:
communicating with a plurality of wireless devices, the plurality of wireless devices including a first set of wireless devices and a second set of wireless devices, the first set of wireless devices including one or more first wireless devices and the second set of wireless devices including one or more second wireless devices;
determining to change a first transmission schedule to a second transmission schedule, the second transmission schedule being associated with the first set of wireless devices; and
transmitting a change indication message indicating the change from the first transmission schedule to the second transmission schedule.

2. The method of claim 1, wherein:
the change indication message is transmitted during an awake period, and
the change indication message is applicable to the first set of wireless devices and inapplicable to the second set of wireless devices.

3. The method of claim 1, wherein at least the first set of wireless devices enter an awake state to monitor for the change indication message.

4. The method of claim 1, further comprising:
receiving a change request from at least one wireless devices of the first set of wireless devices, the change request requesting the second transmission schedule, wherein the determining to change the first transmission schedule to the second transmission schedule comprises:
determining to change the first transmission schedule to the second transmission schedule in response to the change request.

5. The method of claim 1, wherein the determining to change the first transmission schedule to the second transmission schedule comprises:
determining to change the first transmission schedule to the second transmission schedule without receiving a change request.

6. The method of claim 1, wherein the change indication message indicates a first interval associated with the first transmission schedule and a second interval associated with the second transmission schedule.

7. The method of claim 6, wherein a first duration of the first interval is different than a second duration of the second interval.

8. The method of claim 1, wherein the change indication message indicates an interval at which the first transmission schedule changes to the second transmission schedule.

9. The method of claim 1, wherein the determining to change the first transmission schedule to the second transmission schedule comprises:
determining to terminate or extend the first transmission schedule, the change indication message indicating that the first transmission schedule is terminated or extended.

10. The method of claim 1, wherein the first transmission schedule is associated with one or more of a discovery frame, a management frame, or a data frame.

11. The method of claim 1, wherein the first set of wireless devices includes a first type of wireless device and the second set of wireless devices include a second type of wireless devices.

12. The method of claim 1, wherein the first set of wireless devices is associated with a first set of services and the second set of wireless devices is associated with a second set of services.

13. An apparatus for wireless communication, comprising:
a memory; and
at least one processor coupled to the memory and configured to:
communicate with a plurality of wireless devices, the plurality of wireless devices including a first set of wireless devices and a second set of wireless devices, the first set of wireless devices including one or more first wireless devices and the second set of wireless devices including one or more second wireless devices;
determine to change a first transmission schedule to a second transmission schedule, the second transmission schedule being associated with the first set of wireless devices; and
transmit a change indication message indicating the change from the first transmission schedule to the second transmission schedule.

14. The apparatus of claim 13, wherein:
the change indication message is transmitted during an awake period, and
the change indication message is applicable to the first set of wireless devices and inapplicable to the second set of wireless devices.

15. The apparatus of claim 13, wherein at least the first set of wireless devices enter an awake state to monitor for the change indication message.

16. The apparatus of claim 13, wherein the at least one processor is further configured to:
receive a change request from at least one wireless devices of the first set of wireless devices, the change request requesting the second transmission schedule, wherein the at least one processor is configured to determine to change the first transmission schedule to the second transmission schedule by:
determining to change the first transmission schedule to the second transmission schedule in response to the change request.

17. The apparatus of claim 13, wherein the at least one processor is configured to determine to change the first transmission schedule to the second transmission schedule by:
determining to change the first transmission schedule to the second transmission schedule without receiving a change request.

18. The apparatus of claim 13, wherein the change indication message indicates a first interval associated with the first transmission schedule and a second interval associated with the second transmission schedule.

19. The apparatus of claim 18, wherein a first duration of the first interval is different than a second duration of the second interval.

20. An apparatus for wireless communication, comprising:
means for communicating with a plurality of wireless devices, the plurality of wireless devices including a first set of wireless devices and a second set of wireless devices, the first set of wireless devices including one or more first wireless devices and the second set of wireless devices including one or more second wireless devices;
means for determining to change a first transmission schedule to a second transmission schedule, the second transmission schedule being associated with the first set of wireless devices; and
means for transmitting a change indication message indicating the change from the first transmission schedule to the second transmission schedule.
